(19) United States
(12) Patent Application Publication
(10) Pub. No.: US 2014/0243442 A1
(43) Pub. Date: Aug. 28, 2014

(54) MOULDING OF PLASTIC PARTICULATE MATTER

(71) Applicant: JSP International Sarl, Estrees-Saint-Denis (FR)

(72) Inventors: Andrew Coles, Estrees-Saint-Denis (FR); Arnaud Coulon, Estrees-Saint-Denis (FR); Dave Ellis, Estrees-Saint-Denis (FR); Georg Schloms, Estrees-Saint-Denis (FR)

(21) Appl. No.: 14/350,028

(22) PCT Filed: Oct. 5, 2012
(86) PCT No.: PCT/EP2012/069807

§ 371 Date: Apr. 4, 2014

(30) Foreign Application Priority Data
Oct. 6, 2011 (EP) 11290465.1

(51) Int. Cl. B29C 35/08; C08F 110/06

(52) U.S. Cl. CPC B29C 35/0805; C08F 110/06
USPC 521/143; 264/460; 425/174.4

(57) ABSTRACT

A method of manufacturing a moulded article from expanded resin particles, the method comprising: placing the particles and a dielectric heat transfer fluid in a mould located between a pair of electrodes; generating a radio-frequency electromagnetic field between the electrodes; applying the electromagnetic field to the mould to dielectrically heat the heat transfer fluid and hence the particles; and heating the particles to a temperature sufficient to cause their surfaces to soften, so that the particles fuse, thereby to form the moulded article as shaped by the mould; preferably, wherein the radio-frequency electromagnetic field has a wavelength greater than an average dimension (or dimensions) of the moulded article.

This invention relates to apparatus for and methods of manufacturing a moulded article from expanded resin particles by application of dielectric—particularly radio-frequency (RF) or high-frequency (HF)—heating in the presence of a liquid heat transfer agent. The invention has particular relevance to the moulding of articles made from fusing together beads of expanded polypropylene (and similar) foam. The invention also has applications in the manufacture of
synthetic resin particle foams
non-aromatic polyolefinic (ie. polyalkene) particle foams
polycarbonate, polyester and polyamide foams

Specifically, methods for moulding expanded polyolefin (for example polypropylene) resin particles are described.

The invention also has potential applications in respect of the following:
materials that are both not expanded and not polymeric;
food products; and
starch-based bio-foams

Further applications of the invention include the production of:
biopolymers
polycarbonate, polyester and polyamide foams

Expanded polypropylene (EPP) is a closed-cell, polypropylene copolymer plastic foam first developed in the 1970s. EPP has many desirable material properties, which may further be tailored to requirements, including: energy absorption; durability; thermal insulation; buoyancy; resistance to impact, water and chemicals; and a high strength to weight ratio. It may also be recyclable. EPP can be made in a wide range of densities, ranging from high density for energy absorption, medium density for furniture and other consumer products, to low density for packaging. It has also found widespread use, for example, in the automotive industry.

For industrial applications EPP is often sold in particle or bead form, for example as sold under the trade name ARPRO® or P-BLOCK.

Manufacture of the beads involves a process of extrusion of pellets of polypropylene (PP) resin combined with other ingredients followed by expansion (hence expanded PP, or EPP) to form beads. The expansion step involves subjecting pellets to heat and pressure in an autoclave and subsequently discharging them (the drop in pressure to atmospheric pressure causes them to expand). Additional expansion steps may also be used to further decrease the bead density.

The beads are then fused together to form moulded foam parts, both as stand-alone products (such as containers for food and beverages) and as system components (such as automotive seating and bumpers). In practice, a moulded part such as a car bumper may comprise millions of beads fused together.

One method of moulding EPP beads into finished parts involves heating and fusing the beads in a metal mould via steam injection. This is achieved with the use of “steam chests” which may be made of aluminium and typically comprise two parts, each with a hollow space such that when the chest is closed the two spaces define a moulding cavity in which is located a mould or tool into which the beads are placed. The tool typically comprises two complementary (for example, male and female) plates attached one to each of the two parts of the steam chest. The steam chest is also equipped with suitable valves and drains to facilitate the passage of steam.

After initial flushing of the cavity with steam to remove air, EPP beads are introduced into the mould cavity typically by one of two methods (as the beads lack an active expansion agent, these methods are also designed to artificially compress them together so that they are in more intimate contact during moulding to assure cohesion of the final moulded product):
Crack-fill—beads are introduced into an open tool, filling it beyond the extent of the moulding cavity; closing the tool compresses the beads together mechanically.
Counterpressure-fill—beads kept under pressure in a filling tank are injected into a pressurised mould cavity. Being under pressure, the beads are compressed to a reduced volume; as the pressure in the mould cavity is reduced the beads expand, filling it.

Steam is then released into the cavity from the surrounding steam chest. As the steam passes through the assembly of beads, energy is transferred from the steam to the beads, causing them to heat up and inflate. As the surface of the beads heats up it eventually begins to soften and the beads fuse together. The shape of the fused part results from the shape of the tool.

In some processes, the beads undergo a pre-treatment process and are pre-pressurised before the mould filling stage and in some cases a gaseous ‘expansion agent’ is introduced into their structure. This causes the beads to expand even more during the moulding process, resulting in a lower density moulded product than if the beads were not pre-pressurised. As will be clear from the context, the term “pre-pressurisation” is also used in some instances to refer to a pressurisation of the mould before the active moulding step (rather than to pre-treatment of the beads).

Once the fusing is complete, the mould is cooled with water to approximately 60° C. (to lower internal pressure and prevent explosion on release of the moulded part; this process may take some time for conductive cooling to reach the bead centres), opened and the moulded part released. In an automated process the moulded parts are pushed out or ejected as formed. Optionally, a stabilisation process may then be performed.

Steam moulding techniques are often used in preference to alternative plastics moulding technologies, such as injection moulding, due to potentially significant savings of cost and increased productivity; however, it has been appreciated pursuant to this invention that the large volumes of pressurised steam required means that steam chest moulding is very energy inefficient:
in order to fuse the EPP beads they need to be heated from room temperature to their softening temperature of approximately 135° C., at which temperature the beads will (if under sufficient pressure) fuse together. This requires the consumption of large quantities of steam and heating of the entire mould to produce even a small amount of processed EPP (on average some 15 kg-25 kg steam at 3.5 bar for 1 kg processed EPP)
in order to allow the moulded part to be easily and quickly removed from the mould, the mould must subsequently be cooled to allow the steam to condense and thereby reduce the internal pressure inside the mould

Having to heat (and potentially cool) the mould as well as the EPP beads means that over 99% of the energy used in the process is being used for purposes other than heating the beads themselves; energy costs are therefore a considerable percentage of total costs.

Repeated thermal cycling is also detrimental to the operating life of the mould assembly.

In terms of the economics of the process on an industrial scale, the processing time is also important, as this affects the cost of the labour required (whereas the raw material is relatively low cost). This is particularly important for lightweight moulded parts, where the need to heat and cool the mould adds significantly to the cost.

There is therefore considerable interest in novel technologies to fuse expanded polypropylene (EPP) beads to provide moulded foam products, preferably to reduce both the energy used in moulding and the time required. It is estimated that a reduction of the energy cost by 80% could reduce the cost of moulded parts by 15-20%.

Generally, as used herein, the term “softening temperature” preferably includes the temperature or temperature range at which the bead material is soft enough to be able to expand during moulding from its initial bead shape to its final shape in the moulded part, but is also sufficiently rigid to maintain its cellular cell structure without undergoing collapse. The softening temperature of a material is therefore generally below its melting point, although in case of expanded polypropylene it is considered to be slightly above the melting point, such that the material has begun to melt. For EPP in general and especially for ARPRO®/P-Block®, this softening temperature is between 125° C.-145° C. For semi-crystalline thermoplastics, the softening temperature is generally between the start and end points of melting of the crystalline phase.

According to a first aspect of the invention there is provided a method of manufacturing a moulded article from expanded resin particles, the method comprising: placing the particles and a dielectric heat transfer fluid in a mould located between a pair of electrodes; generating a radio-frequency electromagnetic field between the electrodes; applying the electromagnetic field to the mould to dielectrically heat the heat transfer fluid and hence the particles; and heating the particles to a temperature sufficient to cause their surfaces to soften, so that the particles fuse, thereby to form the moulded article as shaped by the mould.

Preferably, the radio-frequency electromagnetic field has a wavelength greater than an average dimension (or dimensions) of the moulded article.

Preferably, the radio-frequency electromagnetic field has at least one of: i) a wavelength of between 300 m and 1 m; ii) a frequency between 1 MHz-300 MHz, 1 MHz-100 MHz, 1 MHz-40 MHz, or 3 MHz-30 MHz; iii) a frequency within an Industrial, Scientific and Medical band allocated for industrial heating; and iv) a quarter-wavelength greater than an average dimension of the moulded article. The radio-frequency electromagnetic field may have a frequency within +/−10 MHz of one of: 13.56 MHz, 27.12 MHz and 40.68 MHz.

Preferably, the temperature to which the heat transfer fluid is heated is sufficient to cause it to vaporise, optionally to fully vaporise.

Preferably, the method further comprises maintaining a pressure in the mould such that the vaporisation temperature of the heat transfer fluid is at or near the softening temperature of the surfaces of the particles.

Preferably, the applied radio-frequency electromagnetic field results in heating of the heat transfer fluid in a first mode when the heat transfer fluid is in a liquid state and optionally in a second mode when the heat transfer fluid is in a gaseous state. More preferably, the heating by the applied radio-frequency electromagnetic field of the heat transfer fluid in the first mode is dominant over the heating in the second mode such that the heating of the heat transfer fluid predominantly occurs when the heat transfer fluid is in the liquid state, preferably in contact with the particles.

Preferably, the amount of heat transfer fluid placed in the mould is determined in dependence on the volume of the mould cavity, and is preferably between 1 ml and 100 ml, more preferably between 2 ml and 50 ml, yet more preferably between 4 ml and 25 ml, per litre of cavity. Alternatively, the mass of heat transfer fluid placed in the mould is determined by the mass of particles placed in the mould, preferably, wherein the mass of heat transfer fluid placed in the mould is in the range 0.1 to 50, 0.125 or 0.14 to 20 or 25, 0.25 to 2, more preferably 0.5 to 1.25, times the mass of particles.

Preferably, the heat transfer fluid comprises water. Preferably, the water has added to it a conductivity increasing impurity. The conductivity increasing impurity may be a salt.

Preferably, the heat transfer fluid has a conductivity of over 3 mS/m.

Preferably, the heat transfer fluid is either: i) placed into the mould at the same time as the particles; and/or ii) pre-mixed with the particles before being placed in or injected into the mould.

Preferably, the heat transfer fluid is used in combination with a wetting agent.

Preferably, the method further comprises controlling the temperature in the mould at least in part by means of control of the pressure within the mould.

Preferably, the method further comprises maintaining the mould at an elevated pressure during moulding, preferably, wherein said elevated pressure is up to 3 bar, preferably up to 5 bar, preferably between 2 and 3 or 3 and 5 bar.

Preferably, the method further comprises pressurising the mould before moulding.

Preferably, the elevated temperature to which the particles are heated is between 80° C. and 180° C., preferably between 105° C. and 165° C., preferably up to 110° C., 120° C., 130° C., 140° C. or up to 150° C.

Preferably, the elevated pressure and temperature within the mould is maintained for a sufficient time to result in the formation of the moulded article from the fusion of the particles.

Preferably, the method further comprises pressurising the particles in the mould before moulding. Pressurising the particles may comprise compressing the particles mechanically or physically, for example by counterpressure filling, by preferably 5-100 vol %.

Preferably, the method further comprises removing air from the mould, preferably displacing the air by the vaporised heat transfer fluid, preferably venting the air via a valve or into an air reservoir, optionally before completion of the moulding.

Removing the air from the mould may comprise displacing the air by the vaporised heat transfer fluid, preferably venting the air via a valve or into an air reservoir.

Preferably, the method further comprises depressurising the mould after fusing of the particles has occurred, preferably as soon as fusing of the particles has occurred.

Preferably, the method further comprises venting the vaporised heat transfer fluid from the mould.

Preferably, the method further comprises a cooling step after moulding, preferably, wherein the cooling step comprises at least one of i) injecting pressurised gas into the mould; or ii) cooling at least one surface of the mould or an electrode, preferably, wherein the cooling step comprises channelling fluid along at least one surface of the mould or an electrode.

Preferably, the particles comprise, consist of or are closed-cell foam particles.

Preferably, the resin comprises, consists of or is an aliphatic resin. The resin may comprise, consist of or be a polyolefin. The resin may comprise, consist of or be a non-aromatic polyolefin (ie polyalkene). The resin may comprise, consist of or be polypropylene and/or polyethylene. The resin may comprise, consist of or be polypropylene. The resin may comprise, consist of or be polyethylene. The resin may comprise, consist of or be a copolymer, preferably polypropylene and its copolymer or polyethylene and its copolymer.

Preferably, the method further comprises controlling the particle or bead density by pre-treatment of the particles, preferably by pre-pressurising the particles before moulding in order to introduce a gas into the particles,

Preferably, the particles are pre-pressurised externally of the mould and subsequently transferred to the mould, preferably, wherein the particles are stored in a pressure tank at an elevated pressure.

Preferably, the mould comprises an enclosed or partially enclosed cavity.

Preferably, mould material comprises a material substantially transparent to the radio-frequency electromagnetic field generated between the plate electrodes, preferably, wherein the mould material comprises i) a polymer, such as polypropylene, high-density polyethylene, polyetherimide or polytetrafluoroethylene; or ii) a ceramic such as alumina, mullite, MICOR or Pyrophyllite. The mould may further comprise a second material not substantially transparent to the radio-frequency electromagnetic field generated between the plate electrodes, preferably wherein the second mould material forms a side wall or lining of the mould and is adapted to be in direct contact with the article being moulded.

Preferably, the electrode plates are spaced apart with a dielectric or electrically non-conducting spacer material, preferably, wherein the spacer material defines at least one side wall of the mould, more preferably, wherein at least one side wall of the mould is embedded in a plate electrode. Preferably, at least one side of the mould cavity is in direct contact with at least one electrode.

Preferably, the mould is adapted to withstand the elevated pressure due to the vaporisation of the heat transfer fluid.

According to another aspect of the invention there is provided apparatus for manufacturing a moulded article from particles, comprising: a pair of electrodes; means for generating a radio-frequency electromagnetic field between the electrodes; a mould, located between the electrodes; and means for applying the electromagnetic field to the mould; wherein the apparatus is adapted to dielectrically heat a heat transfer fluid and particles placed in the mould to a temperature sufficient to cause the particle surfaces to soften, so that the particles fuse, thereby to form the moulded article as shaped by the mould, preferably, further comprising at least one of i) means for placing the particles and the heat transfer fluid in the mould, for example by crack or counterpressure filling; ii) plate electrodes; iii) means for compressing the particles; or iv) means for pressurising the mould.

Preferably, the spacing between the electrodes is adjustable in dependence on the material being processed; preferably, in order to vary the properties of the electromagnetic field applied.

According to a further aspect of the invention there is provided a moulded product obtained using the method herein described.

Further features of the invention are characterised by further claims.

Further aspects include:
Apparatus for moulding plastic particulate matter by application of radio-frequency (RF) heating, comprising:
   mould
   electrode
   material inlet
   liquid heat transfer agent
   optionally, means for applying pressure, preferably in the mould, or alternatively means for compressing the particles
A method of moulding plastic particulate matter by application of radio-frequency (RF) heating and in the presence of liquid heat transfer agent
A method of moulding of articles made from fusing together beads of expanded polypropylene foam by application of RF heating and in the presence of a liquid or fluid heat transfer agent

As used herein, the dimension of an article (such as a moulded article) preferably refers to length, breadth or more typically the thickness of the article, more preferably to an average length, breadth or thickness, and the average dimension of an article. More preferably it refers to the thickness of the article between the electrodes, as in a direction perpendicular or normal to the plane of the electrodes.

Unless indicated otherwise, references to pressure typically refer to “gauge pressure”.

The invention may be defined by the following clauses:
1. A method of manufacturing a moulded article from particles, the method comprising:
   placing the particles and a dielectric heat transfer fluid in a mould located between a pair of electrodes;
   generating a radio-frequency electromagnetic field between the electrodes;
   applying the electromagnetic field to the mould to dielectrically heat the heat transfer fluid and hence the particles; and
   heating the particles to a temperature sufficient to cause their surfaces to soften, so that the particles fuse, thereby to form the moulded article as shaped by the mould, preferably, wherein the radio-frequency electromagnetic field has a wavelength greater than an average dimension of the moulded article.
2. A method according to clause 1, wherein the radio-frequency electromagnetic field has a wavelength of between 10 m and 1 cm, preferably between 1 m and 10 cm.
3. A method according to any preceding clause, wherein the temperature to which the heat transfer fluid is heated is sufficient to cause it to vaporise.
4. A method according to any preceding clause, wherein the heat transfer fluid is either
   i) placed into the mould at the same time as the particles; or
   ii) pre-mixed with the particles before being placed in the mould.
5. A method according to any preceding clause, wherein the heat transfer fluid is used in combination with a wetting agent.
6. A method according to any preceding clause, wherein the heat transfer fluid comprises water, preferably, wherein the water has added to it a conductivity increasing impurity such as a salt.
7. A method according to any preceding clause, wherein the heat transfer fluid has a conductivity of over 3 mS/m, preferably over 7 mS/m.
8. A method according to any preceding clause, wherein the particles comprise any of
   i) closed-cell foam particles;
   ii) copolymer foam particles; or
   iii) expanded polypropylene.
9. A method according to any preceding clause, wherein the method further comprises pre-pressurising the particles before heating, preferably either
   i) wherein the particles are pre-pressurised in the mould; or
   ii) wherein the particles are pre-pressurised externally of the mould and subsequently transferred to the mould, preferably, wherein the particles are stored in a pressure tank at an elevated pressure.
10. A method according to clause 9, wherein pre-pressurising comprises compressing the particles mechanically.
11. A method according to any of clauses 9 or 10, wherein the elevated pressure is at least 1.1, 2, 3, 4 or more than 4 bar, preferably, wherein the pre-pressurising is for a period of at least 1, 2, 3, 4, 8, 12, 16 or more than 16 hours.
12. A method according to any preceding clause, wherein the elevated temperature to which the particles are heated is between 80° C. and 180° C., preferably between 85° C. and 165° C., preferably up to 90° C., 100° C., 110° C., 120° C., 130° C., 140° C. or up to 150° C.
13. A method according to any preceding clause, wherein the mould comprises an enclosed cavity.
14. A method according to any preceding clause wherein the method further comprises maintaining the mould at an elevated pressure during moulding, preferably, wherein the pressure is up to 3 bar, preferably up to 5 bar.
15. A method according to any preceding clause, wherein the method further comprises pre-pressurising the mould before moulding.
16. A method according to any preceding clause, wherein the method further comprises venting the vapourised heat transfer fluid from the mould.
17. A method according to any preceding clause, wherein the method further comprises a cooling step after moulding, preferably, wherein the cooling step comprises at least one of
   i) injecting pressurised gas into the mould; or
   ii) cooling at least one surface of the mould or an electrode, preferably, wherein the cooling step comprises channelling fluid along at least one surface of the mould or an electrode.
18. A method according to any preceding clause, wherein the mass of heat transfer fluid placed in the mould is determined by the mass of particles placed in the mould, preferably, wherein the mass of heat transfer fluid placed in the mould is approximately equal to or less than the mass of particles placed in the mould.
19. A method according to any preceding clause, wherein the mould material comprises a material substantially transparent to the radio-frequency electromagnetic field generated between the plate electrodes, preferably, wherein the mould material comprises
   i) a polymer, such as polypropylene (PP) or polytetrafluoroethylene (PTFE); or
   ii) a ceramic.
20. A method according to any preceding clause, wherein the mould has at least one side wall or lining of a second material not substantially transparent to the radio-frequency electromagnetic field generated between the plate electrodes, preferably, wherein the second mould material comprises polyvinylidene fluoride (PVDF).
21. A method according to any preceding clause, wherein the electrode plates are spaced apart with a dielectric or electrically non-conducting spacer material, preferably, wherein the spacer material defines at least one side wall of the mould, more preferably, wherein at least one side wall of the mould is embedded in a plate electrode.
22. A method according to any preceding clause, wherein the particles comprise a plastic material.
23. A method according to any preceding clause, wherein the particles comprise any of:
   i) a non-aromatic polyolefinic (ie. polyalkene) particle foam; a polycarbonate, polyester or polyamide foam; a polystyrene foam;
   ii) material which is both not expanded and not polymeric; material for use in food packaging products; a starch-based bio-foam;
   iii) a biopolymer; or
   iv) expanded polystyrene.
24. A method according to any preceding clause, wherein the radio-frequency electromagnetic field is of sufficient field strength to vapourise the heat transfer fluid and the pressure in the mould such that the vapourisation temperature is at or near the softening temperature of the material.
25. Apparatus for manufacturing a moulded article from particles, comprising:
   a pair of electrodes;
   means for generating a radio-frequency electromagnetic field between the electrodes;
   a mould, located between the electrodes; and
   means for applying the electromagnetic field to the mould;
   wherein the apparatus is adapted to dielectrically heat a heat transfer fluid and particles placed in the mould to a temperature sufficient to cause the particle surfaces to soften, so that the particles fuse, thereby to form the moulded article as shaped by the mould, preferably, further comprising at least one of
   i) means for placing the particles and the heat transfer fluid in the mould; or
   ii) plate electrodes.
26. A method of manufacturing a moulded article from particles, the method comprising:
   placing the particles and a dielectric heat transfer fluid in a mould; and
   applying a radio-frequency electromagnetic field to the mould of sufficient field strength to vapourise the heat transfer fluid while maintaining a pressure in the mould such that the vapourisation temperature is at or near the softening temperature of the material.

The invention extends to methods and/or apparatus substantially as herein described with reference to the accompanying drawings.

Any feature in one aspect of the invention may be applied to other aspects of the invention, in any appropriate combination. In particular, method aspects may be applied apparatus aspects, and vice versa.

The invention will now be described, purely by way of example, with reference to the accompanying drawings, in which:

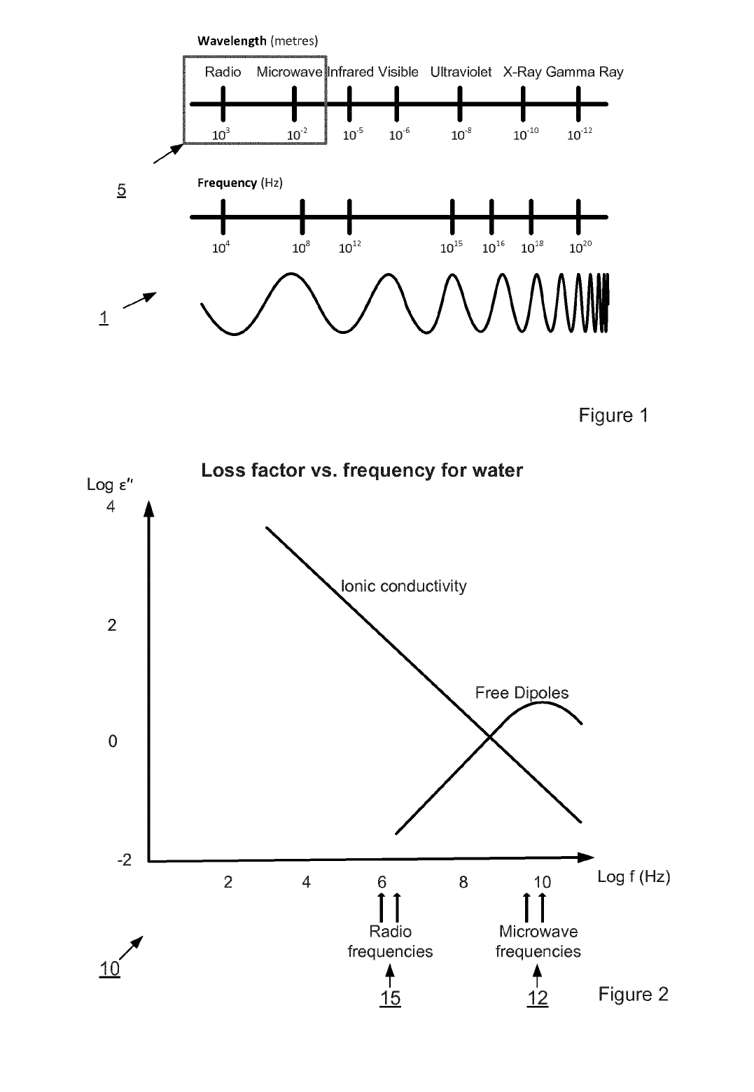

FIG. 1 shows the electromagnetic spectrum;

FIG. 2 shows the loss factor of water as a function of the frequency of an applied electromagnetic field;

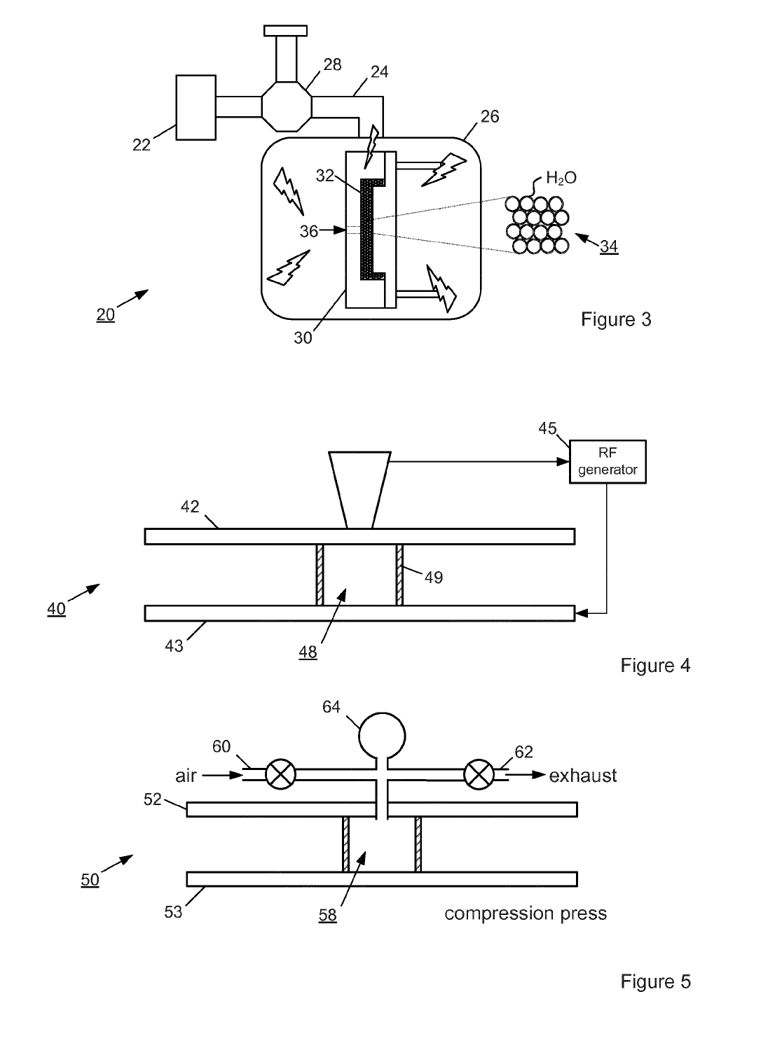

FIG. 3 shows a system for manufacturing a moulded product by means of microwave dielectric heating;

FIG. 4 shows a prototype RF moulding press;

FIG. 5 shows a schematic of a RF compression moulding press;

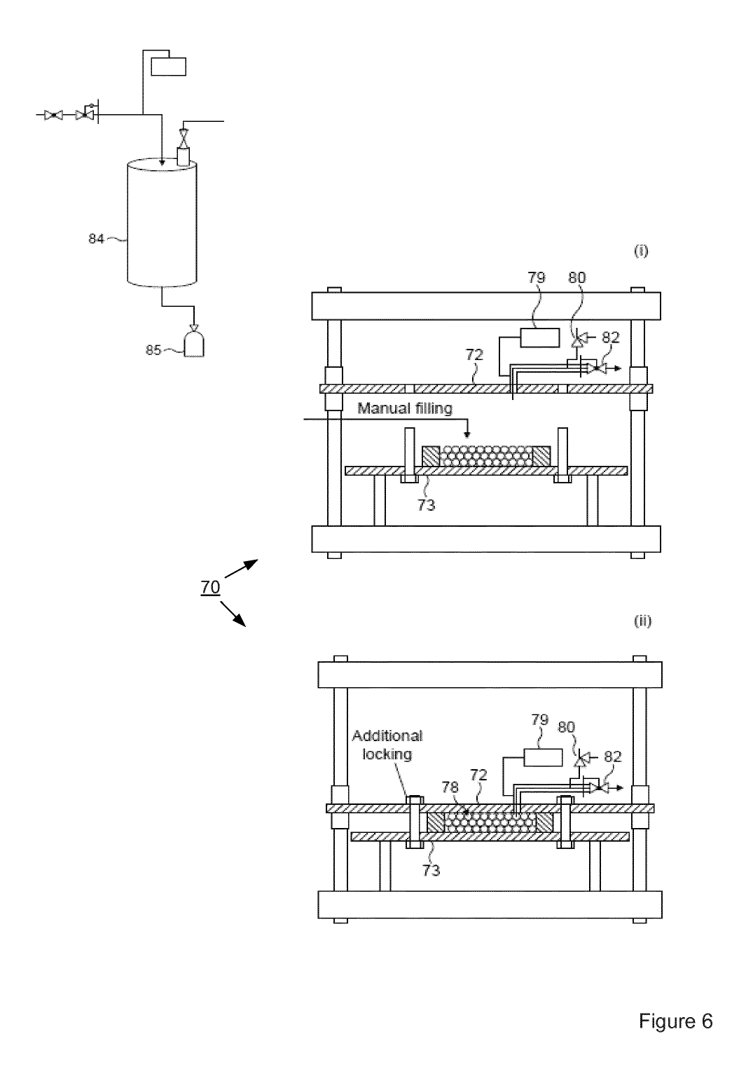

FIG. 6 shows a modified RF moulding press with lockable plates;

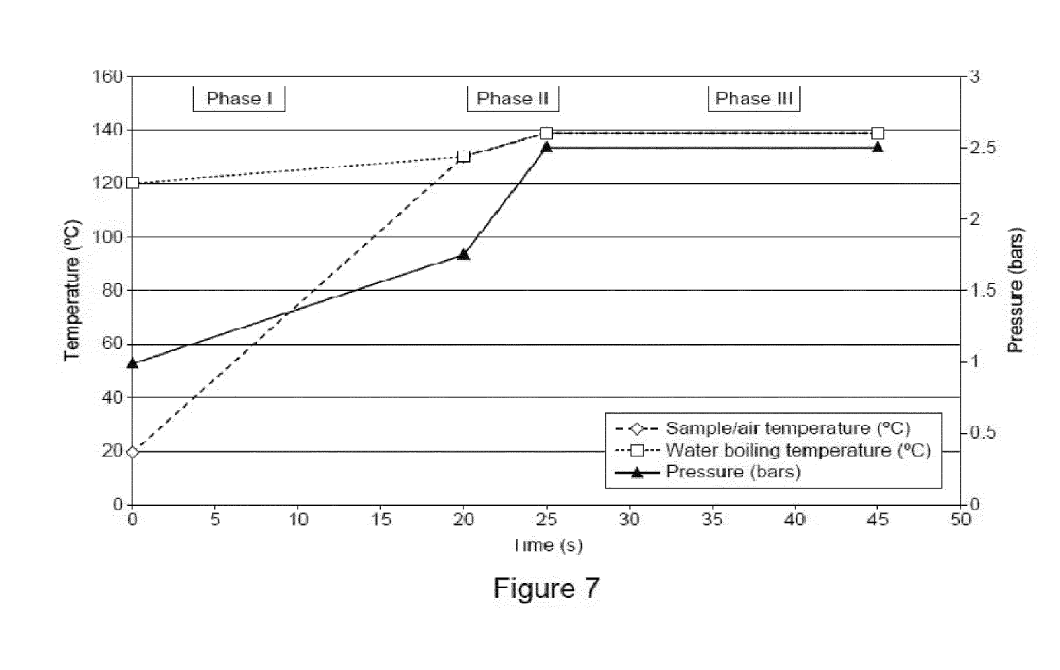

FIG. 7 shows a graph of the environmental parameters observed during an RF moulding sequence;

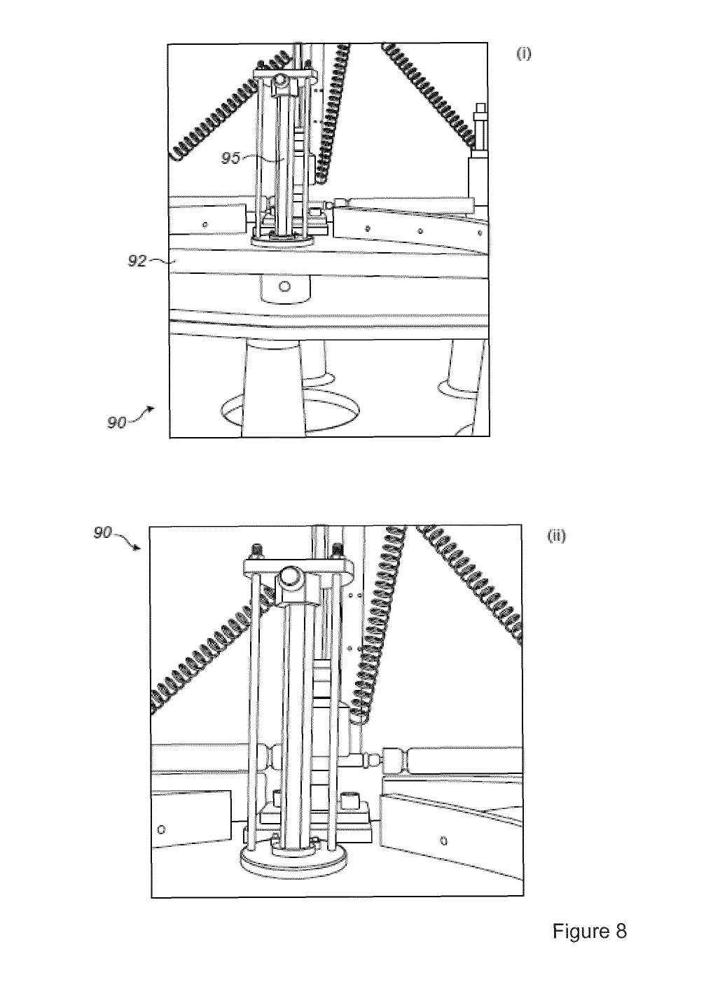

FIG. 8 shows an RF-press with foam pressure sensor incorporated directly into the top RF electrode;

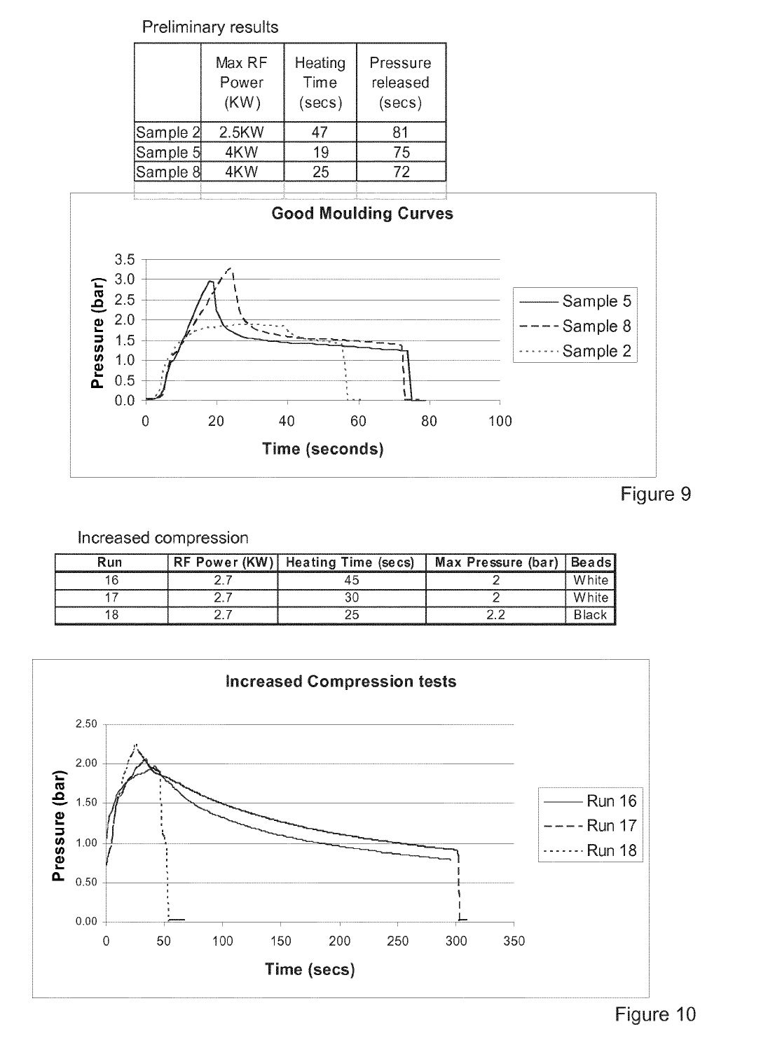

FIG. 9 shows results of air pressure readings during a RF moulding process;

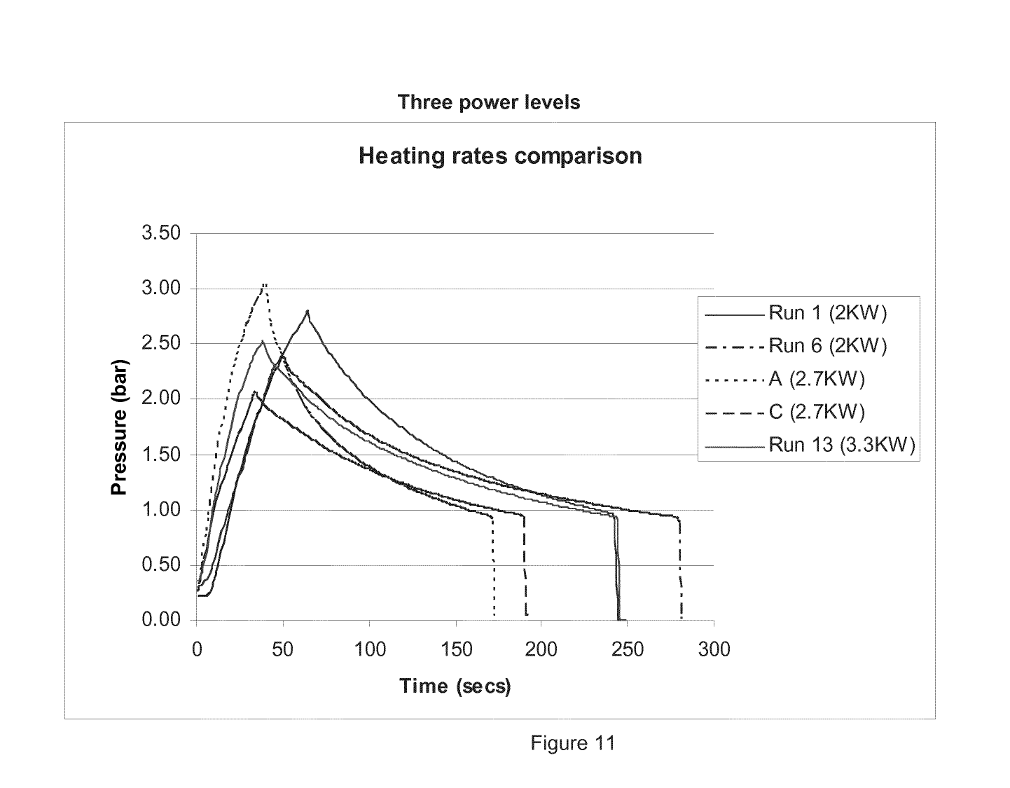

FIG. 10 shows results of air pressure readings during RF moulding trials;

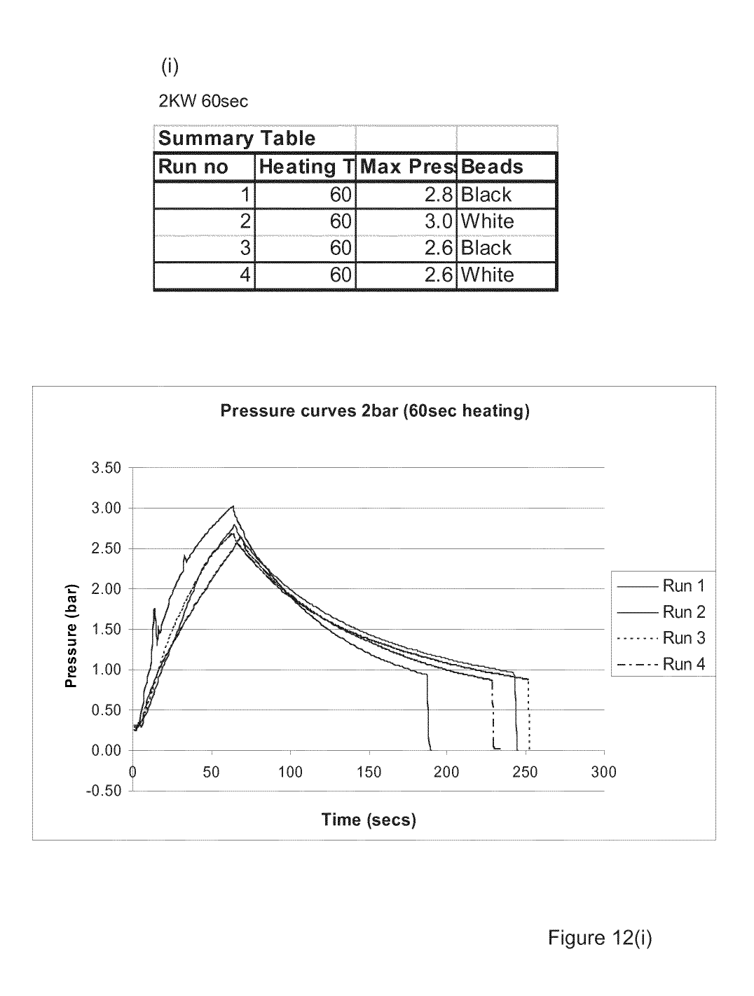

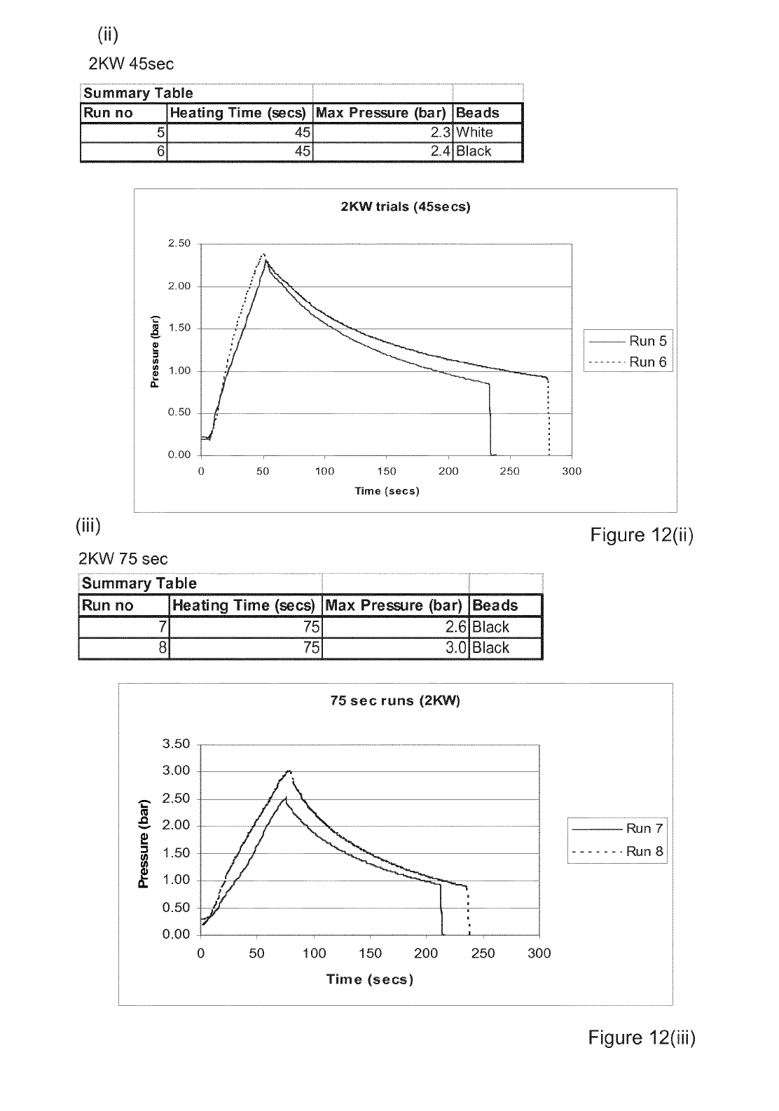

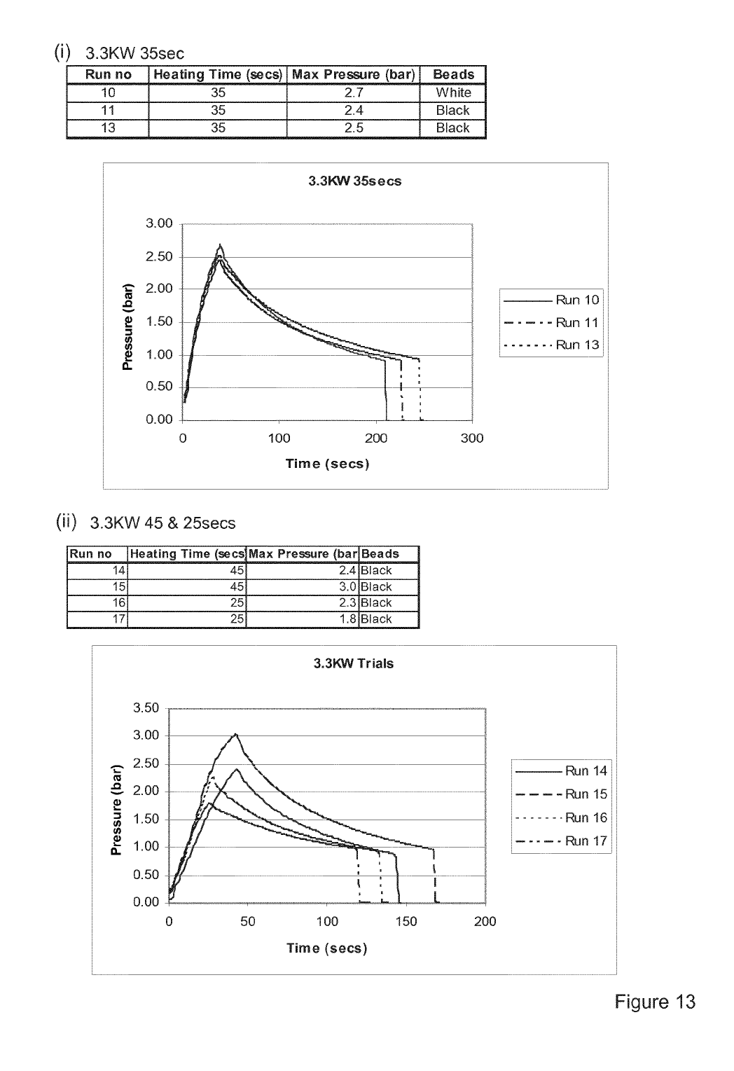

FIGS. 11, 12 and 13 show the results of air pressure readings during a RF moulding process for different RF power levels;

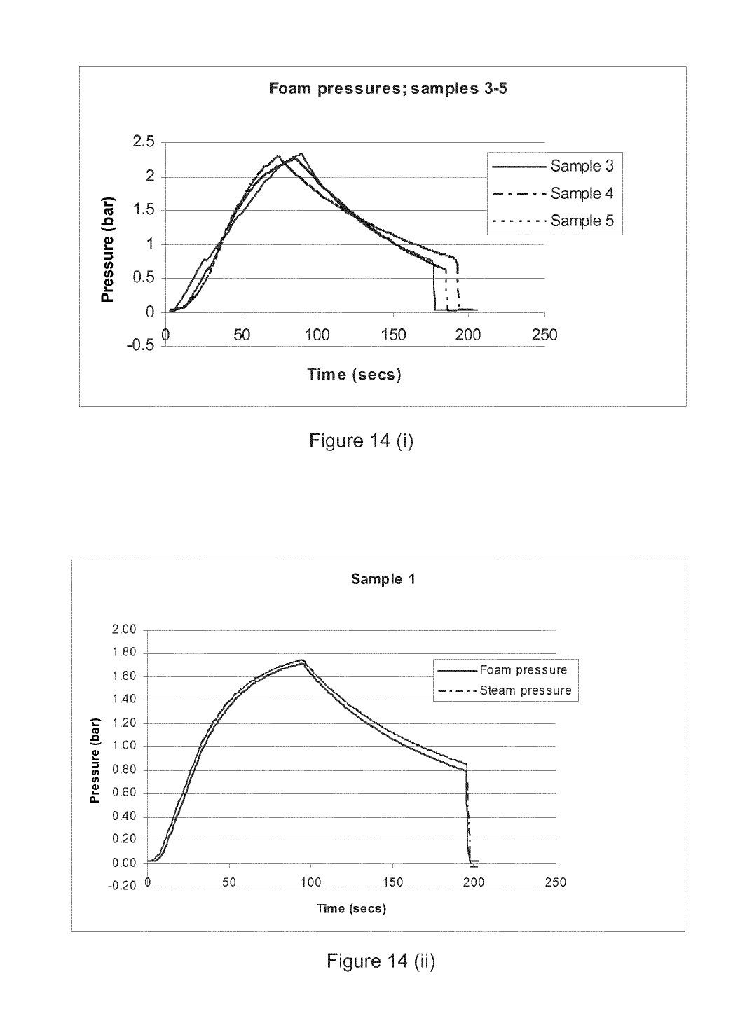

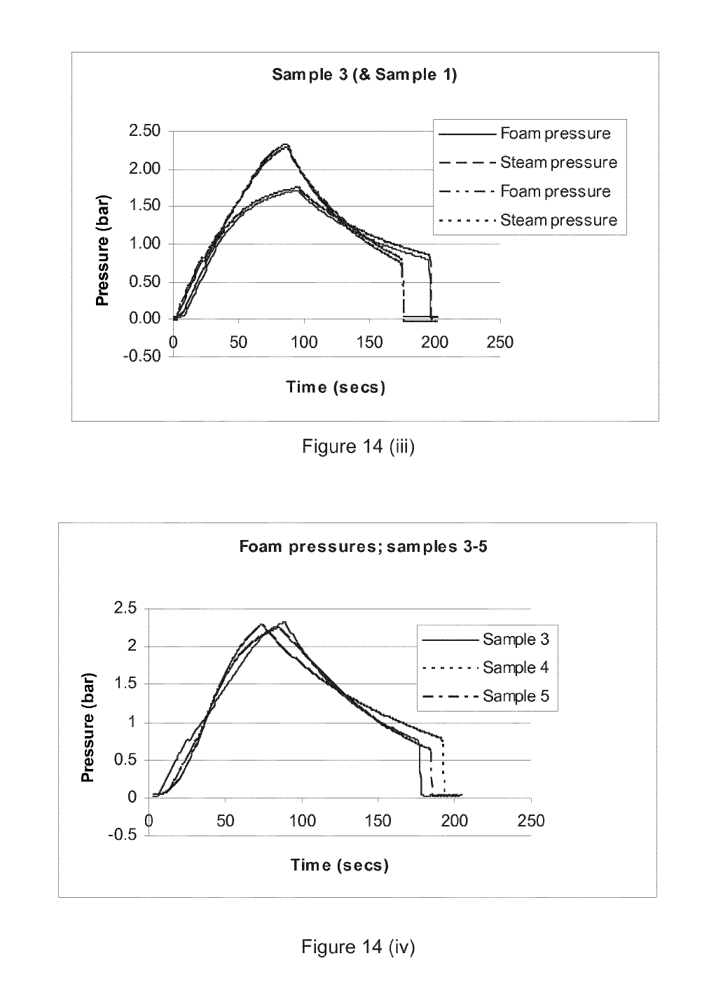

FIG. 14 shows further results of pressure readings during an RF moulding process;

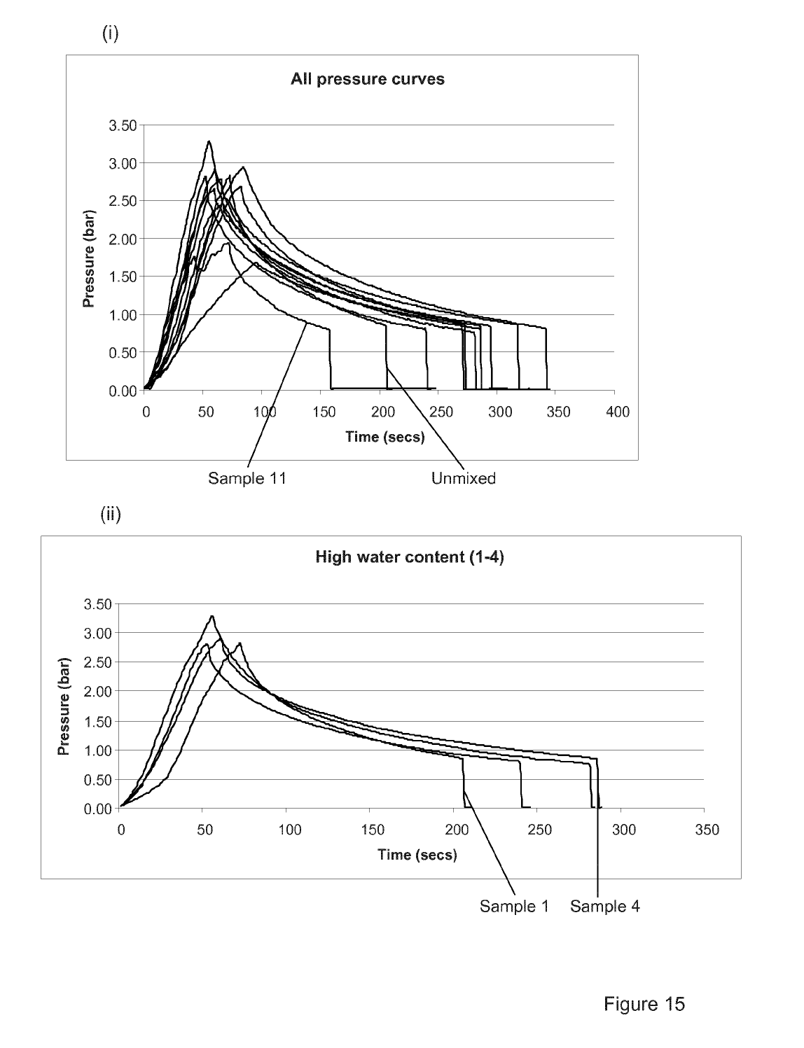

FIG. 15 shows foam pressure sensor readings obtained during trials of large block mouldings;

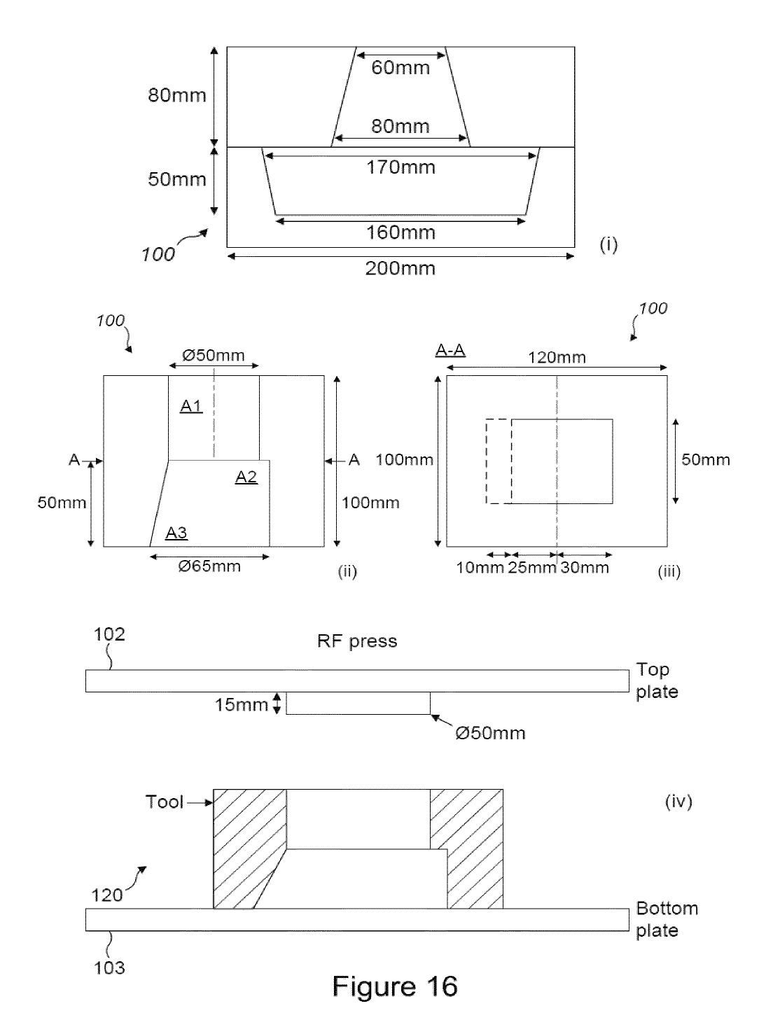

FIG. 16 shows alternative moulding tool designs;

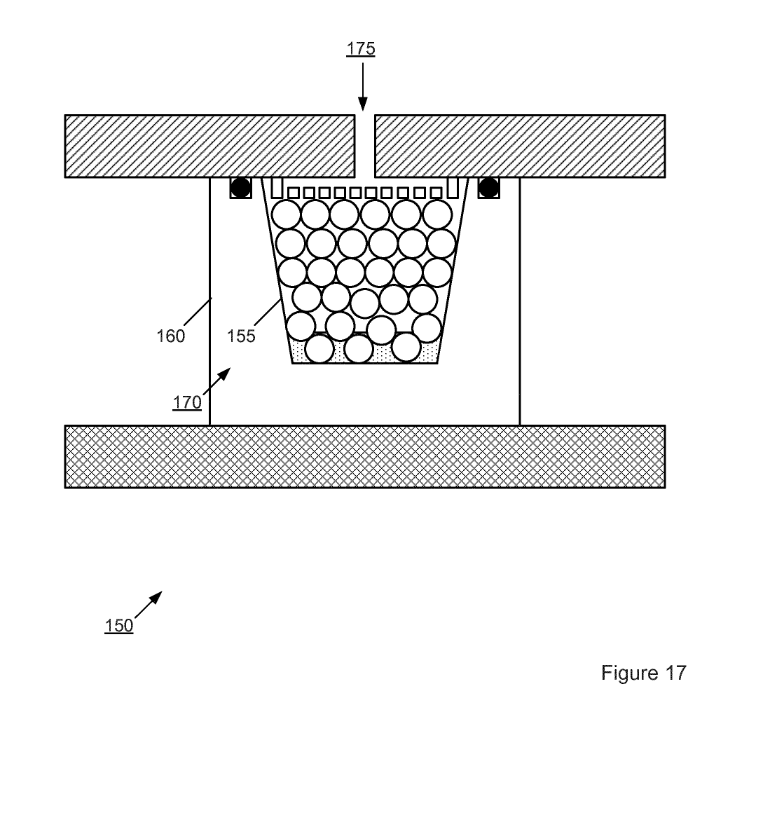

FIG. 17 shows a two-layer RF mould;

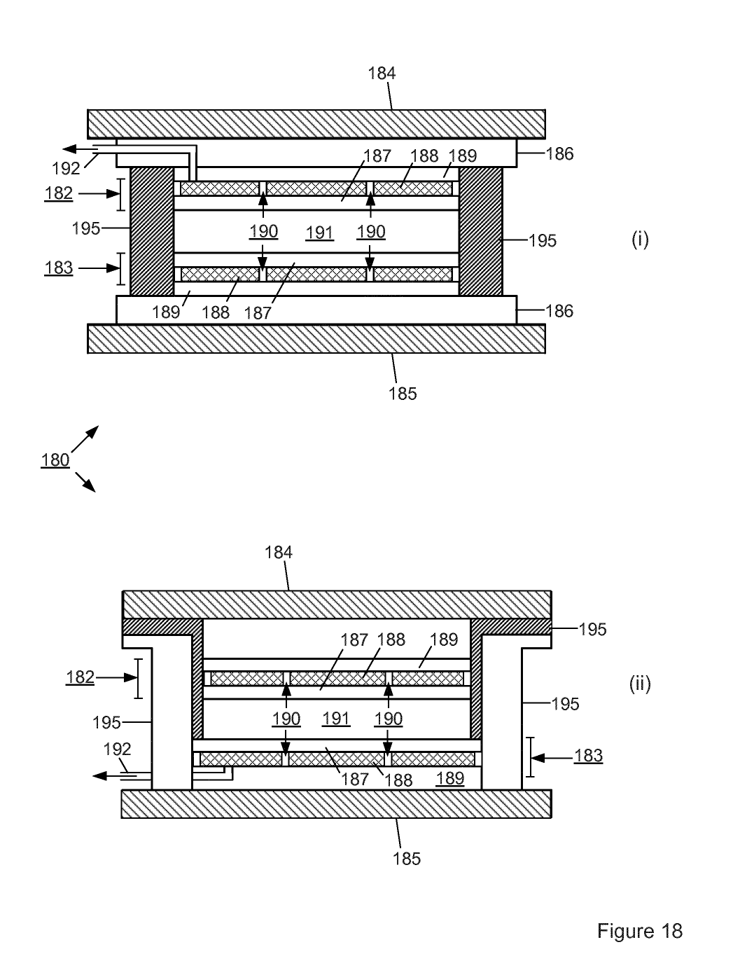

FIG. 18 shows alternative vented RF moulding presses;

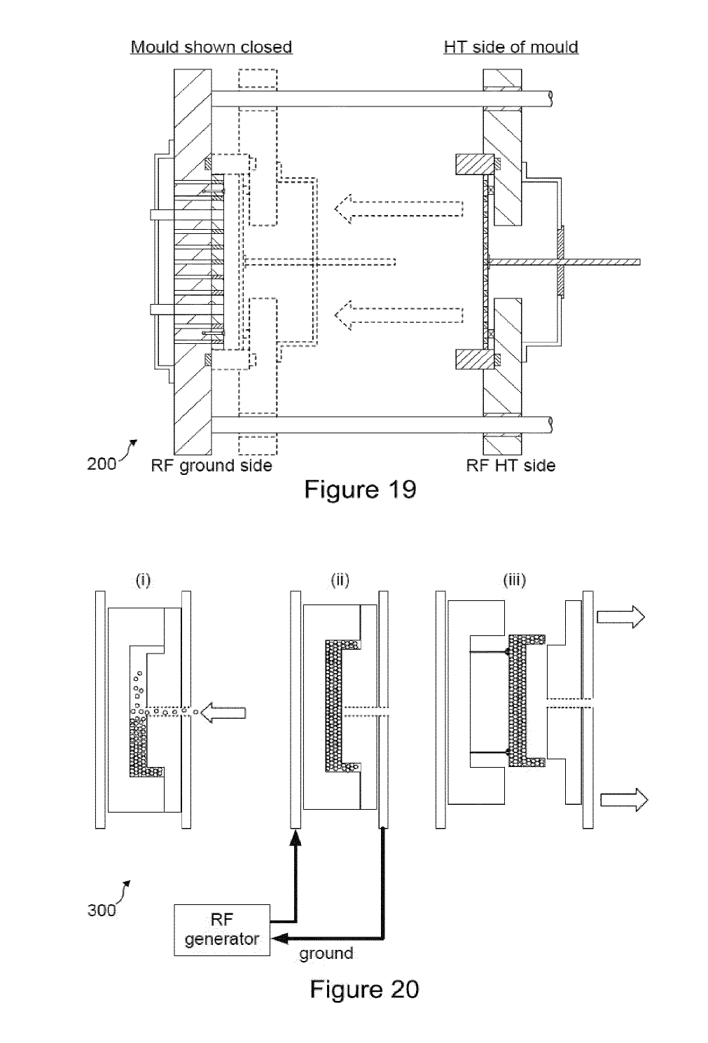

FIG. 19 shows a crack-fill moulding press retro-fitted for use as an RF moulding system;

FIG. 20 shows a production RF moulding sequence;

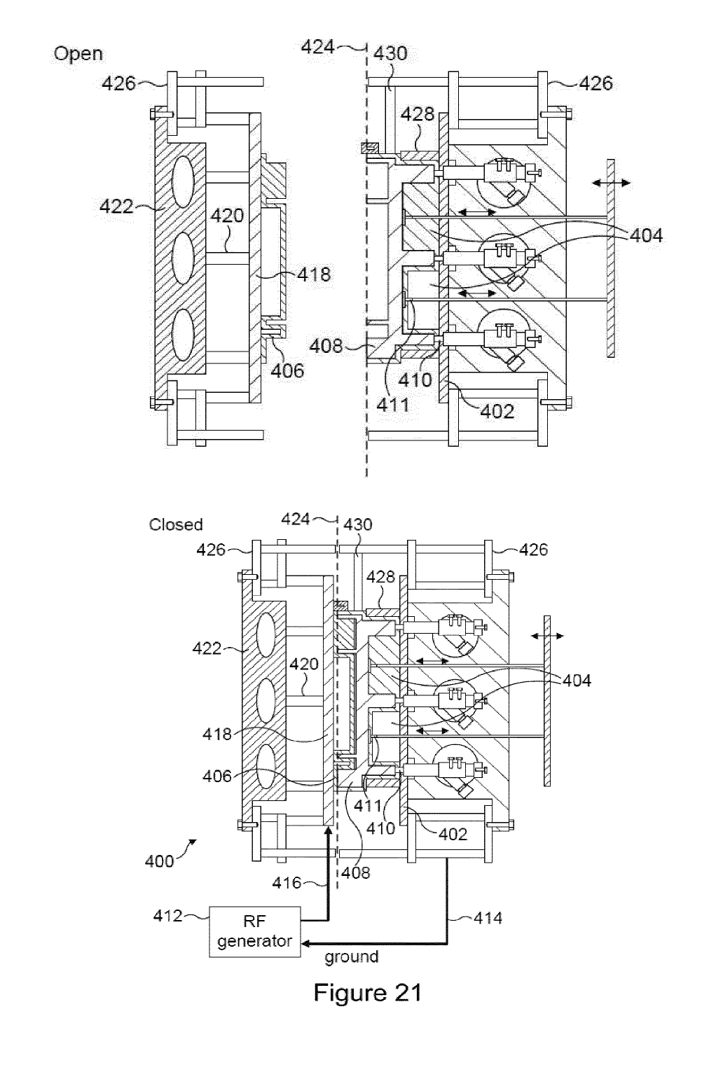

FIG. 21 shows a commercial steam chest moulding press adapted for RF moulding; and

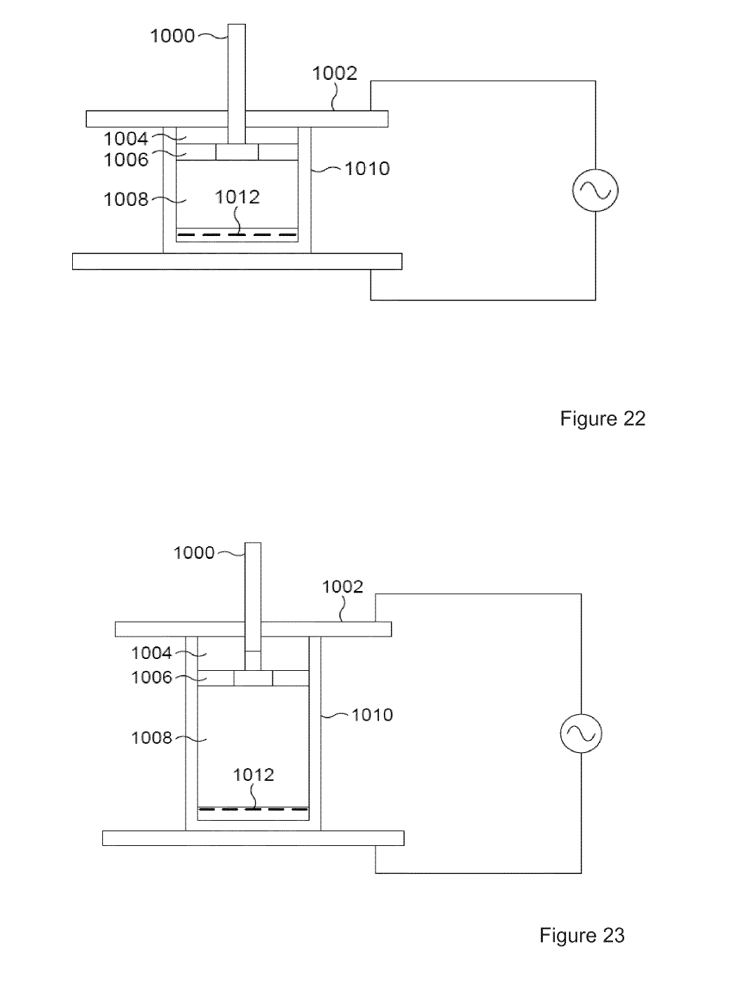

FIGS. 22 to 35 describe some Further and Parameterised Studies of RF Fusion of Polypropylene.

### OVERVIEW

This invention presents an alternative method for the moulding of plastic particulate matter by means of dielectric heating, specifically the application of radio-frequency (RF) or high-frequency (HF) heating and in the presence of a fluid heat transfer agent such as water.

Dielectric heating arises when an alternating high frequency electromagnetic (EM) field is applied to certain materials with poor electrical conductivity. Generally, the EM field causes those molecules of the material with a dipole moment (such as polar molecules) to attempt to align themselves with the frequency of the applied field. Where the frequency of the applied field is oscillating in the radio or microwave spectrum, the molecules attempt to follow the field variations and as a result heat is generated by ‘friction’ between the molecules.

However, as will explained in more detail in the following, there are distinct differences—in terms of method of application (hence apparatus), mechanism and effect—between dielectric heating by radio waves compared to dielectric heating by microwaves.

Power density, P, transferred to a dielectric by an applied electromagnetic field is given by:

P=2πf∈₀∈″E²(in Wm⁻³)

where f is the frequency of the applied electromagnetic field (in Hz); ∈₀ is the permittivity of free space=8.85×10⁻¹² Fm⁻¹; ∈″ is the “loss factor” of the dielectric material, defined as the product ∈ᵣ tan δ, where ∈ᵣ is the relative permittivity and δ is the loss angle (a measure of the inherent dissipation of and therefore heating due to electromagnetic energy, related to the imaginary component of relative permittivity); and E is electric field strength or voltage gradient (in Vm⁻¹).

FIG. 1 shows the electromagnetic (EM) spectrum 1, specifically the frequencies 5 of greatest interest for dielectric heating, namely the radio spectrum and in particular microwaves and radio-frequency (RF) waves.

Generally, the radio spectrum has been described as the part of the EM spectrum of frequencies lower than approximately 300 GHz (corresponding to wavelengths longer than 1 mm), although some definitions include frequencies up to 3,000 GHz (wavelengths of 0.1 mm) also described as in the low infrared.

Some definitions use the terms microwave and radio frequency (RF) to describe adjacent parts of the electromagnetic spectrum. A typical distinction made is one such as the following:
microwaves—comparatively high frequencies of 300 MHz-3 GHz (corresponding to short wavelengths of 1 m-10 cm)
radio waves—lower frequencies of 3-300 MHz (and therefore correspondingly longer wavelengths of 100 m-1 m), potentially down to 1 MHz (300 m wavelength)
although the exact position of the division between the two is often unclear. There are however technical and regulatory distinctions:
each are typically generated by distinctly different methods. For example, industrial microwave heating systems are typically based around magnetrons, with waveguides transmitting power to a resonant or multi-mode cavity. RF heating on the other hand uses a triode or tetrode valve with a resonant LC circuit with transmission lines or co-axial arrangements to deliver power to an applicator. Generally, applicators take the form of a capacitor where the RF power is applied to one or both electrodes.
each results in different dominant interactions between molecules: microwave heating mainly involves interactions with free dipoles; RF heating mainly involves ionic conductivity.
each are defined and allocated by international agreements to particular spectrum bands, known as Industrial, Scientific and Medical (ISM) Bands, for specific uses, the emission of radiation outside these bands being strictly regulated. For example:
   microwave bands include: 896 MHz in the UK; 915 MHz in Europe and the USA and 2450 MHz Worldwide
   RF bands include 13.56 MHz, 27.12 MHz and 40.68 MHz

Permitted frequencies include those within a permitted bandwidth of the aforementioned.

Therefore, as used herein the term “RF”, and similar terms, preferably connotes EM waves of: less than 300 MHz (wavelengths of more than 1 m); preferably less than 100 MHz (wavelengths of more than 3 m); and preferably less than 40 MHz or 30 MHz (wavelengths of more than 7.5 m or 10 m), preferably less than 3 MHz or 1 MHz (wavelengths of more than 100 m or 300 m), preferably less than 300 KHz (wavelengths of more than 1 km), or even down to frequencies of hundreds of Hz (up to wavelengths of thousands of km).

Some embodiments operate within a frequency range of 1-100 MHz (wavelengths of 300 m-3 m), especially 1-40 MHz (wavelengths of 300 m-7.5 m), more especially 3-30 MHz (wavelengths of 100 m-10 m).

Other embodiments operate at (or approximately at) the specific defined and allocated allowed frequencies, for example at 13.56 MHz, 27.12 MHz or 40.68 MHz, typically within +/−10 MHz, preferably +/−1 MHz, more preferably +/−0.1 MHz or even +/−0.01 MHz.

FIG. 2 shows a graph 10 of the loss factor ∈″ of water as a function of the frequency f of an applied electromagnetic field, and how it comprises two different components: losses due to ionic conductivity and losses due to free dipole motion. Typical microwave frequencies 12 are at a frequency close to a peak in the loss factor of water corresponding to free dipole resonances; by contrast, losses for typical RF frequencies 15 are mostly due to ionic conductivity.

Pursuant to the present invention, a series of investigations were undertaken as the concept of RF moulding was developed.

An initial investigation of the potential of dielectric heating for the moulding of plastic particulate matter—specifically EPP—used a microwave-based system. microwave-based systems

FIG. 3 shows a system 20 for moulding plastic particulate matter by means of microwave dielectric heating.

Microwaves are generated by magnetron 22 and are then channelled via waveguides 24 into a chamber 26 where they are reflected off the chamber walls and interact and are absorbed by any dielectric load (e.g. water) placed within the chamber.

A circulator 28 (effectively a microwave ‘one-way valve’) in the wave path prevents microwaves being reflected back along the waveguides 24 and potentially damaging the magnetron 22. The chamber 26 also has appropriate shielding (not shown) e.g. in the form of a Faraday cage, to prevent microwaves from escaping.

Mould 30 located within the chamber 26 has an internal cavity 32 that has the general internal shape and dimensions which conform to the external shape and dimensions of the article to be moulded. Access to the mould cavity 32 is provided by a closure which serves to seal the cavity 32 during the moulding process and which can be opened to allow the moulded article to be ejected or otherwise removed after the moulding process is completed.

The mould 30 is manufactured of a microwave transparent material and is situated in the microwave chamber 26 such that microwaves can travel through the mould walls to irradiate the contents of the mould cavity 32.

In this simplified example, beads of EPP start material 34 are mixed with a liquid heat transfer agent (in this case water) prior to introduction to the mould cavity 32, and are introduced to the mould cavity 32 via an injection port 36.

The microwaves produced by the magnetron 22 dielectrically heat the water until it boils to generate steam. The steam heats the EPP beads 34, which increases the pressure inside the particles and also, once their surfaces reach the PP softening temperature, softens their surfaces. The softening of the bead surfaces combined with the further (attempted) expansion of the beads in the mould cavity 32, cause the particles to fuse or weld to one another, thereby forming a moulded article.

Although this trial showed that microwaves were in principle able to fuse polypropylene beads, the resultant mouldings were found to be only weakly fused.

This is thought to be primarily due to air being trapped inside the mould which if not vented is a very good insulator requiring much longer processing time to achieve fusion between the beads.

Another possibility is non-uniform heating—caused by a combination of the fact that the wavelength of microwaves is of similar or smaller size than the parts being moulded, and by microwaves being repeatedly reflected within the cavity making it difficult to distribute them evenly within the moulding tool. One way to address this issue is to use a system to rotate the sample in the microwave field—although this would necessarily increase the complexity of the system and limit the maximum size of article which could be moulded.

Further issues involved in using microwaves include:
The mould has to be transparent to microwaves, else it too would be heated during the moulding process, thus ruling out metals (used in most commercial tools).
The electric field at the metallic walls of the microwave cavity falls to zero thus producing no heating effect.
Because there is no electric field near the walls of the microwave enclosure the whole mould must be constructed from microwave transparent materials. This requires the moulding tool to be able to withstand both the pressure and temperature developed during the moulding process.

For these and other reasons, the focus proceeded to explore mainly the RF method. Nonetheless, it will be appreciated by those skilled in the art that aspects of the RF-moulding system described are also applicable to a microwave-based system with some modification.

RF-Based Systems

The use of RF heating is generally accomplished by placing the material to be heated between two plate electrodes forming a dielectric capacitor. One electrode is held at high potential and connected to the RF generator, the other is nominally at ‘ground’ potential. The gap or spacing between these electrodes is adjusted to suit the material being processed. In simple systems the gap or spacing between the electrodes can be used to vary the frequency and hence the RF power and electric field strength applied.

Adapting a basic RF heating system for moulding particles, such as polypropylene beads, requires defining the moulding cavity. This is typically constructed from low dielectric-loss polymers which are transparent to radio waves. Additionally it is preferably capable of withstanding the voltage imposed by the radio-frequency field (due to the material having a suitable dielectric breakdown strength) and the pressure and temperature developed during the moulding cycle.

One or both the electrodes may be adjustable to accommodate different sized moulds and to aid ejection of the moulded part.

The mould forms the side walls of the pressure vessel which is directly positioned between the two RF electrodes. A press clamps the electrodes and the polymer mould together to form a closed cavity.

The top and bottom sections and in some cases the middle of the polymer mould typically have machined grooves to house silicone rubber or other seals which act as pressure seals to contain the vapour developed within.

Because the electrode gap is typically fixed by the dimensions of the polymer mould, the resonant frequency of the electrodes and tooling is made adjustable in order for the ‘applicator’ circuit to resonate at the same frequency as the RF generator. This is accomplished by a tuning system—essentially a series capacitor which adjusts the combined capacitance of the two so as the resultant resonates with an inductor at the required operating frequency.

Suitable materials typically possess the following properties:
Transparent to RF: will not heat in the RF field (though as will be explained later, controlled heating can infer advantages)
Temperature resistance in excess of 135° C. (for current commercial copolymer beads eg. ARPRO®), preferably 150° C. (for homopolymer beads)—although higher temperatures may be used for some other bead materials
Low thermal expansion at temperatures expected within the process
Good mechanical stability: robust enough to be used in this process to contain pressures up to 3-4 bar.
High dielectric breakdown strength

Possibly suitable mould materials include:
PP (Polypropylene homopolymer)—RF transparent, although potentially unsuitable for prolonged use at elevated temperatures
PTFE (Polytetrafluoroethylene, commercially known as Teflon)—RF transparent and suitable for use at elevated temperatures, although possible problems with the resulting surface of the moulded product
PEI (Polyetherimide)—RF transparent and suitable for use at elevated temperatures (eg. 200° C.) without detriment to its mechanical properties
A range of other polymers also meet the requirements and could be used for mould construction, such as polyoxymethylene (POM) and its copolymers
Ceramics—although there may be problems with brittleness and low thermal shock resistance

PVDF (Polyvinylidene Fluoride), although not RF transparent, may also be used for fabricating the mould chamber side-walls to allow the mould chamber itself to be heated dielectrically in applications where this is beneficial. For example, heating the internal surface of the mould cavity can provide a better surface finish for the moulded product.

Alternatively, composite moulds may be used, for example, wherein the bulk of the mould is made of RF-transparent material with, for example, a PVDF lining at the internal surface of the mould cavity—thereby offering the advantages of a heated internal mould surface without unnecessary heating of the body of the mould.

RF can also be applied through a material which is microwave transparent, meaning it can be used in cases wherein a microwave system would have heated the mould as well.

As PP itself is transparent to RF a heat transfer agent or medium is required. Water (for example, tap water, due to the presence of ions) is found to be particularly suitable as it is a very strong absorber of RF and when in gaseous form the resultant steam molecules are relatively small and therefore able to penetrate deep into the part being moulded.

The use of RF in preference to microwaves is expected to result in several advantages:

Increased Quality Moulding

As the penetration depth of EM waves is directly related to wavelength, it is believed that the longer wavelengths of RF allow for deeper and more uniform penetration into the part being moulded than microwaves, resulting in greater uniformity of heating and therefore an increased quality of the resultant moulding. This is especially useful for the moulding of larger parts. The applied RF power can also be easily adjusted and the EM field lines can be kept parallel to assist in providing uniform heating of the water.

Simpler Tooling

The structure of a production RF-moulding machine is expected to be broadly similar to current EPP moulding machines (metallic plates, bead filling via fill guns) save for the energy input means. In some variants, as described below, the need for a steam pressure system is entirely removed. Unlike the case with a microwave system, which requires a large cavity in which the mould is placed, the RF solution is significantly easier and less costly to implement. The small number of relatively uncomplicated parts also means it is easier to engineer a robust RF system. The use of RF electrodes allows power to be taken directly into the mould and applied to the moulding material via a liquid heat transfer agent.

No Need to Use an Expansion Agent

An innate advantage of PP as a bead moulding material is that it does not require an expansion agent in order to expand into bead form—unlike polystyrene (PS), which typically contains pentane. As will be described below, RF heating methods do not require the use of a separately introduced expansion agent.

Cost Savings

The use of dielectric heating is expected to result in significant gains in energy efficiency (and reductions in water consumption) through not having to heat the metal of the mould as at present, only the moulded material (although there is a wide variety of sizes of moulded parts, from under 10 g to over 1 kg, an example 1 kg part may require use of a 300 kg mould; some moulds are significantly larger yet). Calculations suggest production systems could reduce energy usage by 85%, water usage by 95%. This in turn could potentially reduce utilities costs by 75%, resulting in a 15% reduction in the cost of moulded parts for parts with a typical density of 60 g/l.

Self-Limiting Heating Effect

The use of RF resulting in heating of the heat transfer fluid in a first mode (ionic heating) when the heat transfer fluid is in a liquid state and in a second mode when the heat transfer fluid is in a gaseous state, wherein heating in the first mode is dominant such that the heating by the applied RF predominantly occurs when the heat transfer fluid is in the liquid state, therefore the heating of the heat transfer fluid (and consequently the particles) becoming self-limiting as the heat transfer fluid vaporises.

The methods described have applications to the moulding of a range of possible materials, including (but not limited to):
polyolefins eg. polyethylene, polypropylene
non-aromatic polyolefinic particle foams

The resin which forms the foamed particles useful in the practice of the present invention is a preferably a polyolefin resin, which is composed of a homopolymer of an olefin component such as a C₂-C₄ olefin eg. ethylene, propylene or 1-butene, a copolymer containing at least 50 wt % of such an olefin component or a mixture of at least two of these homopolymers and copolymers, or a mixture composed of such a polyolefin resin and any other resin than the polyolefin resin and/or a synthetic rubber and comprising at least 50 wt % of the olefin component. The resins are used as uncrosslinked or in a crosslinked state.

The foamed particles of the polyolefin resin used in the present invention are preferably those having a bulk density of 0.09-0.006 g/cm³ (ie. 90-6 g/L)—although other bulk densities are also possible, for example 5-250 g/L—or those formed of an uncrosslinked polypropylene resin or uncrosslinked polyethylene resin as a base resin and having two endothermic peaks on a DSC curve obtained by their differential scanning calorimetry (see Japanese Patent Publication Nos. 44779/1988 and 39501/1995). The DSC curve means a DSC curve obtained when 0.5-4 mg of a foamed particle sample is heated from room temperature to 220° C. at a heating rate of 10° C./min by means of a differential scanning calorimeter to measure it. The foamed particles formed of an uncrosslinked polypropylene resin or uncrosslinked polyethylene resin as a base resin and having two or more endothermic peaks on the DSC curve thereof have an effect of providing a molded article having excellent surface smoothness, dimensional stability and mechanical strength compared with those not having two endothermic peaks on the DSC curve thereof.

Incidentally, the polypropylene resin means a resin, which is composed of a propylene homopolymer, a copolymer containing at least 50 wt % of a propylene component or a mixture of at least two of these homopolymers and copolymers, or a mixture composed of such a polypropylene resin and any other resin than the polypropylene resin and/or a synthetic rubber and comprising at least 50 wt % of the propylene component. The polyethylene resin means a resin, which is composed of an ethylene homopolymer, a copolymer containing at least 50 wt % of an ethylene component or a mixture of at least two of these homopolymers and copolymers, or a mixture composed of such a polyethylene resin and any other resin than the polyethylene resin and/or a synthetic rubber and comprising at least 50 wt % of the ethylene component. “At least 50 wt %” may be understood to mean at least 50 wt %, at least 60 wt %, at least 70 wt %, at least 80 wt %, at least 90 wt % or up to 100 wt %.

No limitation is imposed on the weight of each of the foamed particles used. However, those having an average particle weight of about 0.5-5 mg are generally used.

Several examples will now be described to illustrate possible variations of the RF moulding system. It will be appreciated that any feature described in any of these examples may potentially be used in combination with any one or more features from another example or examples.

### EXAMPLE I

### Proof-of-Concept

The aim of this stage was to carry out a short proof-of-concept study to assess whether effectively fused blocks of polypropylene can be formed using radio frequency (RF) heating of standard commercially-available ARPRO® PP beads—and in particular to demonstrate that good fusion can be achieved in the main body of a moulded EPP sample using RF. Water was used as heat transfer agent.

This work for this proof-of-concept study used a simple RF press with only minor modifications being made for the purpose of an investigation of process parameters. As such, no attempt was made to optimise moulding conditions. For example, it was expected that samples obtained would exhibit poor surface finish as the moulds used had no surface heating facility.

Three different materials were used for construction of moulds within these trials: PTFE, PVDF and polypropylene. All moulds incorporated a silicone rubber seal to ensure a pressure-tight seal was obtained with the top plate. Circular discs were made (of PTFE) which could be placed on top of the beads within the mould and provide compression of beads during the moulding process.
Polypropylene—this mould is transparent to RF but temperature tolerance is unlikely to be sufficient for prolonged use. Some distortion of the mould was seen on repeat use. Release of moulded products proved difficult in some instances although this may be at least partially due to the fact that non-tapered moulds were used. Reinforced PP may therefore be suitable.
PVDF—this mould heats up in the RF field and was therefore used to see whether a better surface finish was obtained by contact of the beads with a warm surface. Good release of moulded products was obtained.
PTFE—this was the preferred material of construction for the moulds in this work. This material is transparent to RF, has high temperature tolerance (up to 260° C.) and gave good release of moulded products. The majority of trials described below used a PTFE mould.

The top press plate is pneumatically operated and in this example has a closing force of half a tonne; commercially, closing forces of several tonnes are not uncommon. This limits the size of mould which can be used in this process as the steam pressure generated in a larger mould will be sufficient to lift the top plate.

In alternative arrangements, clamps are used to hold the top plate in position, which may be of a quick-release variety in order to allow quick access to the mould if an over-pressure situation should arise.

The size of mould used in these trials was therefore restricted to moulds with an internal diameter of approximately 60 mm and 50 mm deep; tapered sides allowed the easy release of fused products. All moulds were constructed with thick walls of typically 2-3 cm or several centimetres (thicker than would be required if the use of metal were possible) to ensure sufficient pressure resistance.

FIG. 4 shows a prototype RF moulding press 40, modified to mould polypropylene beads into simple rectangular blocks for testing purposes. This proof-of-concept system has only minimal modifications; further work is described below in understanding the key process parameters and in integrating the process into a production EPP moulding machine.

RF press 40 comprises two aluminium metal plate electrodes, upper plate 42 and lower plate 43, separated by a distance D. The upper plate 42 is connected to a standard RF generator 45 (in this example, of power 5 kW); the lower plate 43 is connected to ground. The plate electrodes 42, 43 are kept apart to prevent shorting and thus form the upper and lower boundaries respectively of a mould structure 48 (also called a ‘tool’).

The two horizontal boundaries 49 of the mould 48 are made of a dielectric material, for example, a ceramic or polymer such as PTFE, which is RF-transparent and capable of withstanding the temperatures required by the moulding process. To provide increased strength to the mould, the edges of the dielectric sides of the mould are embedded into the plate electrodes 42, 43. In this example, the press 40 is shown is aligned horizontally; alternatively, the press could be aligned vertically, as is common in commercial systems.

The dimensions of the press 40 are approximately 600 mm by 400 mm, and this necessarily restricts the size of the resulting moulded part; nevertheless, this size of mould 48 is sufficient to produce moulded parts suitable for testing eg. a minimum dimension of 60 mm is required for a basic compression test.

The moulding process proceeds as follows:
1. The mould is filled manually with ARPRO® 5135 beads (density 35 g/l, pre-treated in some cases)
2. Approximately the same mass (in this case 6 ml) of tap water is added. Preferably, as little water as possible is added as this will require less RF energy and less post-process drying. The quantity of water required is expected to be correlated to RF energy.
3. The lid with a hole perforation is set on top
4. The press is closed (approx. 500 kg clamping force is applied)
5. Approximately 3.5-5 kW of RF power is applied for 45 s. Both the “14 MHz” and “7 MHz” allowed frequencies are suitable (the wavelength is several metres, far in excess of the dimensions of the moulded article so as to result in deep and uniform penetration into and therefore heating of the assembly of beads, and consequently a uniform quality of moulding). The power required is approximately fixed by the specific heat capacity of the water and the beads, although some energy is lost to the mould, and as condensation.
6. The applied RF heats the water (the heat transfer agent), which has a conductivity of approximately 3 mS/m+/−2 mS/m, generating steam. A conductivity of 3 mS/m is generally nearer the lower end of the desirable conductivity of the dielectric heat transfer fluid; higher values might be appropriate albeit that there are limitations imposed by the conductivity of the system. This heats the surface of beads as well as raising their internal gas pressure and causing them to expand. As the beads soften, their surface melts causing them to fuse, sintering together (i.e. in a physical process rather than a chemical reaction) and taking on the shape of the mould. The steam-led bead expansion and fusing appears to occur as a single process in this case rather than distinct phases and takes approximately 10-20 seconds.
7. RF power is stopped, gate and press opened after a time to allow for stabilisation (approximately 15 seconds after power off)
8. The moulded part is removed from the mould.

The results of experiments undertaken with the equipment described above indicated that EPP beads could in principle be fused using dielectric RF heating, albeit only weakly using this particular arrangement.

The energy requirements of a dielectric heating fusion process are significantly lower than for a conventional steam-chest based process, primarily because the RF energy is used to heat the water surrounding the beads directly rather than heating the tool which is designed to be transparent to the EM waves.

However, the resultant mouldings of this proof-of-concept system were only weakly fused, indicating that these proof-of-concept trials were some distance from a commercial process, for example for polypropylene.

### EXAMPLE II

### Pressurised Mould

The system described in the previous embodiment was a simple plate electrode press and as such did not comprise a pressure chamber and was unable to reach pressures above 3 bar, resulting in a temperature within the mould which was too low to provide good fusion of the polypropylene (PP) beads.

Evidently, for effective moulding to occur beads must be heated above their softening temperature, weakening the bead structure sufficiently for them to expand without subsequently collapsing. This typically requires temperatures in the range 105° C.-165° C.; the lower temperatures for copolymers, the higher temperatures for homopolymers. Examples of suitable temperatures include approximately 120° C. (+/−10° C.). for low density polyethylene; 135° C. (+/−10° C.) for standard ‘automotive grade’ ARPRO®. The latter equates to a steam pressure of approximately 3 bar being generated within the mould.

Generally, the maximum temperature reached will to some extent determine the degree of fusion achieved. For example, 105° C. is sufficient to begin fusing certain types of polyethylene, with good fusion being achieved at 120° C.

FIG. 5 shows a schematic of a RF compression moulding press 50, adapted to apply compression to a sample being moulded by means of pressurised air. RF plates 52 and 53 enclose a mould cavity or chamber 58 which has air-tight sealed sides. Air supply via pipe 60 is used to pressurise the mould chamber 58. Exhaust or relief pipe 62 allows the air to be vented. The pressure is monitored by manometer 64. For example, when EPP beads are moulded, the pressurisation in the mould is typically 1.0-3.0 bar; for moulding of EPE beads, it is typically 0.5-1.5 bar.

FIG. 6 shows a modified RF moulding press 70 with lockable plates 72, 73

A polymer or ceramic mould as described earlier is modified by the addition of seals to ensure a pressure-tight seal is maintained between the mould 78 and the press RF electrode plates 72, 73.

This allows the mould 78 to be pressurised in order to raise the temperature of the water and therefore steam within the mould to the softening temperature of PP of approximately 135° C.-140° C. (+/−10° C.), which requires approximately 3 bar of steam (the precise pressure required is fixed by steam tables, which relate pressure to temperature).

The system comprises the following elements:
RF ground plate 72, RF power plate 73
Polymer or ceramic mould 78 (0.14 litre volume)
Air pressure inlet/steam exhaust bore_(˜5 mm) with sintered metal filter
Perforated lid
O-Ring seal
Pressure gauge/manometer 79
Safety pressure release valve 80
Adjustable pressure relief valve 82
(optional) Pressurisation vessel 84
(optional) Net bag 85

The dimensions of the mould 78 and bead filling are as follows:

Volume of mould

| | | |
|---|---|---|
| Diameter | 350 | mm |
| Height | 40 | mm |
| Volume | 3847 | cm² |
| Volume | 3.85 | l |
| Density | 30.0 | g/l |
| Part weight | 115.4 | g |

| | |
|---|---|
| No. of trials | 20 |

Pressure gauge 79 is fitted to the top plate of the RF press to monitor the pressure generated within the mould 78. This pressure gauge 79 is linked to a compressed air inlet which allowed pre-pressurization of beads within the mould.

Safety pressure release valve 80 (typically set at between 3-5 bar) is to prevent excessive build up of pressure within the mould 78.

Adjustable pressure relief valve 82 is added on the exterior of the RF cage to allow the pressure in the mould during the process to be controllably released during the moulding process. In this example, the pressure relief valve 82 is fitted to the pressure gauge/manometer line at a T-piece.

As previously, the moulding process relies on dielectric heating of approximately 3 mS/m water (the heat transfer agent) to heat, expand and fuse PP beads to form a moulded article.

The mould is sealed so that the steam cannot escape during the heating process. Controlled venting is used to regulate the pressure and therefore the temperature within the mould, thereby also removing air from the system. The required temperature to be reached depends on the product being moulded, being approximately 95° C. for EPS, 140° C. for EPP higher, and intermediate 120° C. for low density PE.

As pressures of up to 3.5 bar are generated in the mould, in order to prevent loss of steam pressure by lifting of the top electrode plate locking mechanisms are used between the plate and the press frame. Conductive bolts cannot be used as these will affect the RF field. These locking mechanisms are in addition to the pre-existing locking mechanisms used in the proof-of-concept apparatus.

The moulding process proceeds essentially as described for the previous embodiment except for additional pressurisation step:
1. The lower mould is filled manually with ARPRO® 5135 bead
2. Approximately the same mass (in this case 6 ml) of tap water is added.
3. The lid with a hole perforation is set on top
4. The press is closed (approx. 500 kg clamping force is applied)
5. Air pressure is applied through hole in ground plate (approx. 1-1.5 bar)
6. Approximately 3.5-5 kW of RF power is applied for 45 s. Both 13.56 MHz and 27.12 MHz frequency bands are suitable.
7. Pressure gauge rises to approx. 2.5 bar
8. RF power is stopped, gate and press opened (approx. 15 s after power off)
9. The moulded part is removed from the mould.

Approximate calculations of the energy and power required are as follows:

| | | |
|---|---|---|
| Required energy EPP | 22 | kJ |
| Required evaporation | 10 | g water |
| Required energy water | 29 | kJ |
| Total energy | 51 | kJ |
| Time to heat, boil & pressurize | 20 | s |
| Required power | 2.5 | kW |

Thus a sufficiently pressure-resistant mould may require as little as 10 g of water to mould approximately 5 g of ARPRO® 5135 beads.

FIG. 7 shows a graph of the environmental parameters observed during an RF moulding sequence. A possible explanation is as follows:
Phase I: As the water and beads heat up, temperature and pressure increases in the tool till water boiling point. Initial pressure of 1 bar implies an increase of water boiling temperature from 100° C. to 120° C.
Phase II: The increase of pressure during this phase could be due to volume reduction of air due to expansion of beads.
Phase III: Pressure & Temperature stabilization. However, this is only a quasi-stable step: water is evaporating from the bottom and from around the beads. Condensation of water appears during contact with cold press plates; the condensate is deionised water which being free of dissolved ions is lower in conductivity and therefore is effectively transparent to RF heating. The heating process is effectively self-limiting, given that the steam (being deionised) is not heated significantly by the RF. Hence this is potentially a further advantage of RF-based systems over microwave-based systems. Possible countermeasures are proposed below.
As the process continues, some or all of the water is consumed.

No volatile expansion agent appears to be required, but of course here air is used as a form of expansion agent.

Monitoring Temperature & Pressure

Temperature and pressure are key parameters in the RF moulding process. However, locating a temperature or pressure sensor (or indeed any sensor) directly in the mould is complicated by the inadvisability of placing conductive material (probes, sensing lines, etc.) between the RF plates.

Various methods may be used to monitor the temperature within the mould, for example:
Thermocouples—although the insertion of thermocouples into the mould may cause distortion of the RF field. This effect may be dependent on the position of the thermocouple within the mould eg. thermocouples may only be suitable for measuring temperatures close to the RF plates, preferably at the ‘ground’ electrode.
Fibre Optic Probes—these may need to be protected by a thin glass tube to minimise the risk of probe breakage. This may therefore reduce the accuracy of the readings obtained as the probe will not be in direct contact with the beads.
Temperature labels—these can be attached to the mould interior prior to the fusion process and used to record the temperature at the mould surface.

Combinations of the above could also be used, ideally with say thermocouples or fibre optic probes inserted into different positions throughout the mould in order to provide the option of recording the temperature of the fusion process and evaluate temperature uniformity throughout the moulding.

Monitoring of process parameters can then be used to optimise the fusion conditions and understand uniformity in different samples sizes.

A pressure valve and associated instrumentation may already be being used to measure and control pressure within the moulding tool.

A further advantage of monitoring the pressure in the mould during the moulding process is that it also provides a way of tracking progress of the moulding process and identifying the process end-point: pressure increases during the moulding process as the beads expand, then stops when expansion has completed.

A pressure gauge or sensor could be located above the top RF electrode; however, as this is likely to be some distance away from the mould it is unlikely to provide an accurate measurement of foam pressure within the mould.

FIG. 8 shows an RF-press 90 with top RF electrode 92 having incorporated directly into it foam pressure sensor 95, thereby monitoring pressure at the surface of the mould. The sensor element is linked to the air supply and to a suitable pressure transducer, for example a Danfoss MBS3050, which can measure pressure from 0 to 10 bars by providing output signal current of 4-20 mA.

Some degree of care may be required in some systems when interpreting the pressure readings, even when readings by different methods appear consistent. For example, trials using both a foam moulding sensor and a simple pressure gauge on the top RF plate of the press appeared to show generally good correlation; however, this was found to be caused by a lack of good contact between the foam sensor and the beads (its design preventing it from protruding very far through the compression block on the top plate), suggesting this sensor was actually measuring steam pressure.

When considering the choice of pressure sensor it is also important to consider the additional hazards introduced by the use of RF. For example, the membrane of foam pressure sensors may be fragile and easily damaged by an arcing within the RF system. Although the use of more optimised moulding conditions should reduce this risk it may not be possible to eliminate it entirely.

Alternative methods of monitoring include: ways of allowing direct visual monitoring of the process, for example, using an open moulding press (may not be practical where elevated pressure moulding is required), a clear PVC, polycarbonate or quartz glass mould; or the use of fibre optics sensors.

Operating the mould in an open state was not found to be effective, with resultant slow steam propagation and low bead expansion of approximately 10-15% leading to a moulded density with non-pre-pressurized ARPRO® 5135 resulting in poorly moulded part of density of 38 g/L (approximately the same as the unprocessed bead density).

This initial work looked to identify a set of conditions which could reliably and repeatedly provide moulded products with a good level of fusion of beads. No attempt was made at this stage to minimise the quantity of water or power used in moulding.

Pre-Pressurisation of Beads

Pre-pressurization is a pre-treatment used prior to moulding with (for example) EPP beads. The objective is to introduce a gas, principally air, into the bead's cell structure to provide a source of internal pressure which subsequently functions as a supplementary expansion agent and enhances expansion of the beads during the moulding process.

Typically, beads are pressurized from zero to several atmospheres of air pressure over several hours and then held at that pressure for several hours more. For example, pre-pressurising may comprise storing the beads in a pressure vessel at 3-4 bar for 16 hours to several days before use. As EPP is a closed-cell material, movement of air inside the cells is mainly via diffusion.

The beads are subsequently released into a net bag for transport—optionally, the bag may be dipped in water or some other heat transfer agent at this stage.

An example of a re-pressurization vessel 84 and net bag 85 are shown as optional in the apparatus shown in FIG. 6.

In some alternatives, the beads may undergo pre-pressurisation directly in the tool before moulding. The advantage of pre-pressurising the beads in a separate vessel over in-mould techniques is that it reduces the standing time in the tool.

The previous trials were carried out using non-pressurized beads. This was due to the fact that samples of pre-treated beads could not be removed from the pressure vessel without de-pressurizing the entire vessel.

Moulding trials using pre-pressurized beads may therefore have to be carried out in quick succession over a short period of time (for example, approximately 1 h maximum) before the effects of pre-treatment are lost.

A typical sequence of steps for RF-moulding with pre-pressurisation is as follows:
1. Pre-pressurize ARPRO® 5130 or 5135 in a small vessel (e.g. for 24 h at 2 bar constant pressure)
2. Add moisture (compared to the traditional method, only a very small amount is required)—alternatively, water may be added once the beads are in the mould
3. Transfer to (e.g. PTFE) mould, manually filling the lower round mould on the press with the beads. To reduce the risk of beads depressurising during transfer the time between removal from the vessel and heating in the mould should be minimised, say to 5 min or less.
4. Press is locked, additional locking secured (i.e. the mould is sealed to prevent steam escaping).
5. RF field (using 5 KW RF generator) is applied to the beads—potentially for a short period only eg. 5 sec.
6. Water on bead surface heats up, starts to vaporise to form steam, heats bead fuses expanding beads.
7. Pressure rises to 3-3.5 bar, temperature to T=135° C.
8. Excess steam is vented by a pressure relief valve pre-set to 3 bar (relaxing the pressure during the process may further aid bead expansion).
9. Water on the bead surface is heated up and starts to vaporize and fuse the expanding beads.
10. After approximately 5 sec, RF stopped, stem pressure released via valve to atmospheric pressure and the mould left to stand.
11. After heating, the mould is allowed to stand for approximately 3 minutes before the press is opened. This allows time for the product to cool. If the press is opened immediately after heating the beads continue expanding out of the top of the mould.

This generally results in a well-fused moulded part with reasonable surface appearance for a non-actively cooled mould on the perimeter area, but very “raw” look on top and bottom surfaces (those in contact with the RF plates).

Optionally, the beads may initially be pre-warmed and/or subsequently cooled (e.g. by injection of compressed air).

Another alternative is to pressurise the beads in the moulding tool cavity by compressing them with the press, for example by using a compression disc.

A typical sequence of steps for this procedure is as follows:
1. Mould filled with beads
2. Water added (6 mL)
3. Compression disc placed on top of beads
4. Press closed
5. Pressurize mould to 0.5-1 bar
6. RF applied: 5 KW generator used with power levels generally between 3-4 KW.
7. When pressure reading reaches a maximum level the RF is turned off
8. Pressure released using external valve
9. Allow mould to cool
10. Press opened

The process sequences described above do not aim to optimise conditions, so some variation in say water volume added, power level applied and moulding time might be expected to be required in order to obtain an effectively moulded block of EPP with this particular equipment.

These process sequences also do not allow for controlled venting of steam from throughout the mould (for example as achieved in existing process via core vents) and also do not provide a mechanism to ensure an even surface finish (for example via a mould surface coating which is heated by RF).

Nonetheless, well-fused samples showing good expansion of beads were reproducibly obtained. Use of pre-treated beads generally resulted in higher pressures during moulding, with fusion pressures in the range of 3-3.5 bar. The far greater expansion seen in these trials compared to non pre-treated beads also resulted in no significant air gaps in the sample. As expected for a non-heated mould, less complete fusion was seen at the surface of the samples.

These trials showed that good fusion was observed when a pressure of over 2.6 bar was obtained. Several factors were required to ensure that this pressure was reached within the moulding process, including:
Use of good pressure seals throughout the system. This includes the seal between the mould and the top press plate, good sealing between the two layers of the top plate and ensuring that all valves are pressure tight.
Pressurisation of the full mould to 0.5-1 bar. This initial pressurisation reduces the need for steam to fill the whole space within the pressure system. Steam within the pipes of the pressure system may recondense on cold, unheated surfaces which reduce the capacity for the system to build up pressure. This may also result in insufficient water remaining within the mould for the RF to heat.
Tuning of the RF system. The system was re-tuned when different mould materials with different dielectric properties were used. The small amount of water used in these trials (only 6 ml water) means accurate tuning is essential to ensure effective heating of this very small RF load.

Once the maximum pressure observed within the system (typically 2.5-3 bar) had been reached, continued heating showed no further increase in pressure and the levels of reflected power increased. This indicates that most of the water has been converted to steam and there is no longer much water remaining for the RF to heat.

Using a well-tuned, pressure-tight system where the mould was pre-pressurised as described, a pressure of 2.5-3 bar was reproducibly obtained after a period of approximately 45 seconds. Better fusion was observed when the PTFE disc was placed on top of the beads to compress the sample.

Samples moulded under these conditions consistently provided products which were well-fused throughout the body of the sample with less effective fusion observed at the surface (using PTFE mould). In some cases air gaps were seen in the sample and this was attributed to poor expansion of beads not filling all spaces between them.

When a PVDF mould was used more complete fusion was seen at the surface of the product. However in this case it appears that the surface heats more rapidly than the main body of the sample as the interior of these samples appeared incompletely fused.

This work shows that RF can effectively fuse EPP beads. This fusion took place at comparable pressure to that used in existing EPP moulding processes.

Further aspects of relevance include the following:
Minimising quantity of water used in fusion.
Quantifying the process energy efficiency.
Demonstrating applicability of RF moulding for larger and more complicated parts.
Use of non-RF transparent mould surfaces to provide a good surface finish on mouldings.
Requirement for steam manifold system and venting system throughout entire mould.
Modifications of the RF press to enable larger products to be moulded.
Incorporation of a hydraulic press system to increase the closing pressure of the press to enable the moulding of parts of a larger size.

The moulding of larger parts should provide the following process advantages:
Increased efficiency of RF system by use of higher load.
Higher proportion of energy used to fuse beads rather than lost by heat transfer to mould.
Reduced water content per weight of beads.

As required, the press could then be further modified to include porous electrodes and a manifold system. This would enable effective venting of the steam from multiple points within the mould.

Trials with such a modified system could be used to investigate factors including water usage, energy usage, optimisation of cycle time and uniformity of moulding observed in larger parts.

Furthermore, the mould design could be optimised—for example by using surface doping—to provide a good surface finish to moulded parts.

### EXAMPLE III

### Subsequent Studies

The following describes further studies of the RF-moulding process.

For the moulding of larger samples a greater closing force of the RF press is typically required. Two further PTFE moulds were designed to mould taller, cylindrical samples.
Mould 1: 80 mm diameter, 80 mm height
Mould 2: 80 mm diameter, 120 mm height
the moulds were tapered to allow easy release of moulded parts.

The increase in mould size results in a significant increase in distance between the RF press plates and consequently re-tuning of the system was therefore be required for each new mould.

Trials using these new moulds investigated the following:
fusion parameters (time, power level and pressure) required to give effective moulding of samples within the new moulds.
quantity of water required for fusion, initially using the same proportion of water as used in previous trials (approximately 100% water mass relative to beads), subsequently gradually reducing the water quantity to identify the minimum required to give good fusion.
uniformity of fusion, using monitoring of the temperature at several positions within the mould and subsequent visual inspection of moulded products.

The equipment used for these further studies comprised an RF press with a foam pressure sensor attached and fibre optic temperature probes introduced through the lower plate of the press to enable monitoring of the temperature during the moulding process.

FIG. 9 shows results of air pressure readings during RF moulding trials carried out with a simple cylindrical mould, using 20 ml of water for samples comprising approximately 15 g of beads, without pre-pressurisation of the beads and without pre-pressurisation of the mould.

The three samples all appeared to result in well-fused samples for both pressures of less than 2 bar and greater than 3 bar.

As is evident from the graphs, there are considerable differences between the curve shapes although the end results appear very similar. It therefore appears that there may be a range of conditions which can be successful.

The length of time delay before pressure relief used in these samples is probably unnecessary to produce good samples but is due to needing time to open the press and release the pressure in the tool.

One important factor which has been identified from these trials is that the process works better with water of slightly higher conductivity. For example, rather than using untreated tap water of 3 mS/m conductivity, better fusing resulted from using water of 7.5 mS/m conductivity (achieved with the addition of very small quantities of salt to the tap water).

This requirement may be less important for larger samples where a higher volume of water makes it simpler for the RF to couple in; however, it provides a more reproducible process and enables rapid heating with small samples.

FIG. 10 shows results of air pressure readings during RF moulding trials.

Some of the above trials resulted in incomplete fusion of beads at either the top or the bottom of the mould. The mould lid was therefore redesigned to give increased bead compression. This consistently gave products which appeared to have good fusion throughout and no loose beads at the periphery.

For this set of trials, a maximum pressure of 2 bar was attempted. Although there was a variation in the time to achieve this pressure, the final results generally appear comparable. This set of trials also included one run (18) where the sample was depressurized rapidly after heating instead of waiting until a demoulding pressure of 1 bar. From a simple visual inspection of the product, this did not seem to have a major effect on the fusion observed.

FIGS. 11, 12 and 13 show the results of air pressure readings during an RF moulding process for different RF power levels; in particular, moulding at three different power levels and three time periods for each power.

| RF Power (KW) | Heating time (sec) |
|---|---|
| 2.7 | 35 |
| 2.7 | 45 |
| 2.7 | 60 |
| 2.0 | 45 |
| 2.0 | 60 |
| 2.0 | 75 |
| 3.3 | 25 |
| 3.3 | 35 |
| 3.3 | 45 |

Generally, higher power levels do not result in a more rapid heating rate.

At a nominal power of 3.3 KW, the power output from the RF generator was quite unstable. This is potentially a result of attempting to heat a relatively small load (water). The actual power supply to the product may therefore not be significantly higher for the runs at 3.3 KW compared to those at 2.7 KW.

The moulding results appear to be fairly good at relatively low pressures (e.g. 2 bar) and do not appear to be dependent on a long heating time. Some of the trials at higher pressure and/or longer time appear ‘over-cooked’, with overheated and therefore collapsed beads.

There is some variability between curves obtained under repeat conditions. This may be due to factors such as slight variations in water added, variations in the mould temperature, effectiveness of the system pressure seal and fluctuations in power output of the generator.

These trials were carried out to confirm that effective heating with such a tall shape—and consequently an increased separation between the electrode plates—can be achieved. The results show that the equipment set-up works well and that the material can be effectively heated.

FIG. 14 shows further results of pressure readings during a RF moulding process.

| | | | mass of | Water | Bead | Max | |
|---|---|---|---|---|---|---|---|
| Sample | Beads | Power | beads | volume | preparation | Pressure | Fusion |
| 1 | White | 2.2 KW | 52 g | 50 mL | none | 1.7 | poor: some chunks |
| | | | | | | | fused material |
| 3 | White | 2.2 KW | 52 g | 50 mL | premixed | 2.3 | Good, complete |
| | | | | | with water | | shape but some |
| | | | | | | | loose beads at |
| | | | | | | | periphery |
| 4 | White | 2.2 KW | 52 g | 50 mL | presoaked | 2.3 | Bottom 2/3 of shape |
| | | | | | in water | | fused; loose beads |
| | | | | | | | at top |
| 5 | Black | 2.2 KW | 52 g | 50 mL | premixed | 2.2 | Bottom 2/3 of shape |
| | | | | | with water | | fused; loose beads |
| | | | | | | | at top |

“Black” beads comprise around 3 wt %, typically between 0.5-5 wt %, carbon black.

Some trials showed that only low pressures were achieved (e.g. sample 1) and that most of the beads did not fuse. This may be due to poor distribution of water which means that steam generated does not reach all parts of the mould.

A repeat trial (sample 3) where the beads were pre-mixed with (3 mS/m) water was attempted to achieve an even distribution of water throughout the mould. This provided a reasonably well fused sample although there are still some loose beads at the periphery.

Some attempts in this series of trials to repeat this result with this equipment gave inferior results (sample 4 & 5) where the products were not fused in the top half of the mould (although they were still much better that results without pre-mixing with (3 mS/m) water).

The pressure curves obtained with samples 3-5 are very similar which indicates that the differences seen in the product cannot be attributed to differences in pressure and all other parameters (water quantity, power level) were also kept constant.

Further work focussed on understanding the effect of water distribution within the beads and how the provision of an air escape path (by means of a manifold or pressure-relief valve) could reduce the effect of air counter-pressure in the mould blocking passage of the steam through the assembly of beads.

Results of Large Block Mouldings

Another set of trials investigated the inclusion of a 200 ml ‘air reservoir’. This was found to have a highly beneficial effect, resulting reproducibly forming well-fused samples.

A summary of the parameters for the trials is as follows:

| | | | | | Max | |
|---|---|---|---|---|---|---|
| | | Water | Power | Heating | pressure | |
| Run | | volume | level | time | reached | |
| (Sample) | Beads | (mL) | (kW) | (sec) | (bar) | Comments |
| 1 | Black | 30 | 3.2 | 72 | 2.8 | Slower heating rate |
| | | | | | | of possibly due to |
| | | | | | | use cold tool (first |
| | | | | | | run of the day) |
| 2 | Black | 30 | 3.2 | 53 | 2.8 | |
| 3 | Black | 30 | 3.2 | 56 | 3.3 | |
| 4 | Black | 30 | 3.2 | 61 | 2.9 | |
| 5 | Black | 12 | 3.2 | 83 | 2.7 | Reduction in water |
| | | | | | | volume gives slower |
| | | | | | | heating rate |
| 6 | Black | 12 | 3.2 | ≈80 | ≈2.5 | Pressure curve not |
| | | | | | | recorded |
| 7 | Black | 20 | 3.2 | 67 | 2.5 | |
| 8 | Black | 20 | 3.2 | 85 | 2.9 | |
| 9 | White | 30 | 3.2 | 60 | 2.7 | |
| 10 | White | 30 | 3.2 | 65 | 2.8 | |

The quantity of water used in moulding was varied from a minimum of about 12 mL to a maximum of 30 mL—which for 52 g of beads in a 1.5 litre mould cavity (as used in these trials) equates to about 8 ml to 20 ml of water per unit volume of tool cavity, or a ratio of water weight to bead weight in the range of approximately 25%-60% (for these trials). More rapid heating was observed with the samples containing more water as the larger load heats more efficiently within the large press applicator.

In all cases heating was stopped when the pressure (as viewed on the pressure gauge) was about 2.5 bar.

FIG. 15 shows foam pressure sensor readings obtained during trials of large block mouldings. These vary slightly from those seen on the pressure gauge (they are generally slightly higher). This is possibly due to the pressure gauge being slightly displaced from the tool due to the presence of our air reservoir. Pressure readings from the foam sensor would therefore be expected to be more accurate.

For all tests the products were left to stand in the tool until the pressure had dropped to approximately 1 bar. The time to reach this pressure shows considerable variation between runs. As this particular tool is comprised of three sections held together by the press there was be a small amount of pressure leakage between sections; the rate of this may have varied between runs.

Two of the runs show markedly different pressure profiles to the others.

The first is labeled ‘unmixed beads’. In this case the beads were mixed with water directly before the run. By contrast, all other beads samples had been soaked in water for a minimum of an hour. This pre-soaking seems to give a better distribution of water throughout the beads and facilitates heating. The ‘unmixed beads’ sample showed a very slow rate of heating and gave very poor fusion.

In instances where some water escaped from the tool and the pressure within the fusion process remained relatively low, steam production could nevertheless generate enough pressure such that the samples still appeared to be well-fused—and were also obtained in a drier form.

In summary, this later study indicated that well-fused samples could be obtained with:
Pre-soaking of beads in water
Inclusion of an air reservoir to enable the tool to be filled with steam,

Alternative Mould Designs

FIG. 16 shows examples of alternative moulding tool designs 100. Further work with a more complex mould, for example, a mould comprising two cylindrical portions of differing dimensions, would allow the moulding of a shape of considerably larger volume and also the investigation of the level of uniformity of fusion which is observed with a non-uniform geometry.

These designs assume the following:
clamping force is around 1,200N (70 mm diameter*3.2 bar)—which limits the complexity of the mould design
maximum pressure needed to mould is 3 bar, possibly down to 2.5 bar or even approximately 1.5 bar
maximum area is 4000 mm²

The revised mould is designed to enhance expansion and fusion of the beads inside the tool, rather than facilitate filling.

The various areas identified in the figure have the following purposes:
Area 1 (A1): The cylindrical shape provides for crack-fill. Cylindrical and square shapes were chosen because beads expansion rather than filling was to be the key factor investigated.
Area 2 (A2): Square shape is used where good expansion of beads is needed.
Area 3 (A3): The angle at Area 3 is to see how fusion will be outside of the expected steam path.

This moulding tool is milled from a 120×100×100 mm block; alternatively, a tool for moulding samples for tensile strength testing is rectangular 150×30×80 (height) mm.

An alternative moulding tool 120 is also shown between top and bottom plate RF electrodes 102, 103, ready for moulding.

### EXAMPLE IV

### Further Considerations and Enhancements

Although there may appear to be only a few operational parameters, there are numerous issues which a production system would take into account, including:
Thermal expansion—For polymer tools, the effect of thermal expansion of the metal electrode plates on heating is likely to affect the integrity of the sealing of the system and would need to be accounted for
Heating uniformity
   within the mould, could be assessed by means of fibre-optic probes positioned within the tool to record the temperature
   at the surface of the moulded part, could be measured by means of thermocouples built into the RF ‘ground’ electrode
   specific design of the electrode
Water requirement—The minimum amount of water required to provide effective fusion (potentially determined by repeated trials to establish whether the required temperature and pressure achieved)
Selection of an optimal water quality
Use of a wetting agent—could potentially improve bead coverage by reducing surface tension
Process efficiency—could be calculated from energy consumption determined, for example, from recording input and reflected power
Cycle time—could be reduced by, for example:
   using higher RF power levels to speed the heating stage and/or
   introducing a post-moulding cooling stage.
      Although some cooling is to be expected due to comparatively large thermal inertia of the mould compared to the amount of energy involved in the RF moulding process, further cooling could be achieved by pressurized air could be injected via air piping and/or the incorporation of water channels into the mould and electrode surfaces. Cooling would also likely improve the surface quality of the moulded product.
Warming of mould surfaces—Water channels could be used to warm the mould surfaces and thereby potentially assist with achieving uniform surface fusion
Electrode enhancements, such as:
   pores to allow venting
   pre-warming/post-cooling (electric/air)
   water channels on electrode surface
Quality control either simply by observing and rating bead fusion at the surface and core of moulded parts and/or by assessing mechanical properties
Considering the degree of shrinkage of the moulded part (which can be considerable in the steam moulding process); although this may potentially be mitigated by the use of an RF transparent mould
Suitability of the mould construction materials for repeat cycling and moulding of complex shapes; potentially using an alternative material such as PVDF, which although not electrically conductive is not RF transparent therefore heats up in the RF field, potentially improving the surface characteristics of moulded parts
RF power levels and frequencies would nevertheless still need to comply with regulatory and safety requirements
Lining the mould—The simplest mould may be non-lined, but this can affect the quality of the surface finish of the moulded part.
Shaping the mould—to allow for easier removal of the moulded part and/or to allow for checking of uniformity of fusion and the surface quality e.g. use of a longer mould with a deeper (120 mm) cavity
Steam flow features—grooves and pinholes, designed to make steam flow through the side walls
Regulation of the air pressure into the mould cavity (required to allow the steam to reach the necessary temperature for bead fusion) and evacuation of this air so as to prevent it blocking the interaction of the steam with the beads—for example, by use of a manifold and pressure-relief valve.
Use of alternative heat transfer agents, other than water, optionally with a surfactant.

Cooling

The surface quality of the moulded product may be improved by arranging for the inner wall of the polymer mould to be actively cooled after the moulding process

Mould Filling

As previously described, the two common industrial methods for filling a mould with beads are crack-fill and counterpressure-fill. These methods may be incorporated into a production RF moulding system, although some modifications may be required.

The basic principle of crack-fill is that the mould or tool is not fully closed during the bead filling step. This is easiest to achieve with the mould having two distinct sides: a male side and a female side (although it is possible to use two female sides, better results are obtained with the male/female combination). One side of the mould is usually locked, the other is moved into place. However, as the tool temperature increases, thermal expansion may cause the metallic plates to elongate, potentially by several millimetres. This could result in slippage between the ceramic former and the metallic parts. Therefore, in order to avoid contact between the RF electrodes, an isolation ring may be placed around the male side where the two sides are face-to-face and a further isolating joint, formed of ceramic shims, may be used to maintain the gap between the two electrodes.

In counterpressure-fill, the beads are pneumatically injected into moulds. Commercially available fill guns include, for example, those supplied by Erlenbach Maschinen GmBH. Typically, these use compressed air (and in some variants a spring mechanism) to pass beads from an over-pressurised silo to the fill-gun head and via a bead injection port (for example, in the top electrode) into the moulding cavity. In some embodiments, at the end of filling, a further injection of pressurised air may be applied. The mould is typically porous or perforated in order to allow air to escape as the beads are blown in. Once the beads have been injected, the venting can be regulated to affect the pressure in the mould. In some embodiments the use of a pressurised line to fill the mould may be advantageously used to pre-pressurise the mould i.e. once filling is complete, maintaining the pressure in the mould at an elevated level for the subsequent moulding process.

Variants may use hybrid filling arrangements.

Water/Steam Injection

The use of RF to create steam in-situ means that much of the piping associated with traditional steam chest moulding is no longer required; the RF method essentially provides a “passive” steaming process.

In alternative arrangements, modified RF moulding apparatus feature water-saturated air, ‘wet steam’ (steam which contains water droplets in suspension) or steam injection ports to allow for the introduction of water into the tool in what might be termed “active” steaming.

Small amounts of steam may be introduced into the mould during the filling process, for example, combining the wetting and filling steps by blowing beads into the mould with a fill gun using steam instead of air. Alternatively, to avoid any modification of filling procedure, the water could be introduced after the mould is filled.

Potentially, active steaming could enhance the RF moulding process, reducing further the amount of water required by ensuring contact with every bead; however, the requirement for an active steam connection would be less attractive to industries such as the car industry.

Venting

It is difficult to accurately predict the amount of water required for the moulding process; however a simple outline calculation of steam consumption could be as follows:

RF Moulding Energy calculator

| | | | | | | | Steam |
|---|---|---|---|---|---|---|---|
| | | | Temp. | | Spec. | | equiv- |
| Element | Mass | | Diff | | heat.cap. | Th. | alent |
| Tool (Material & | 0.2 | kg | 70 | K | 0.24 Whkg*K | 3Wh | 0.006 kg |
| Temperature | | | | | | | |
| difference) | | | | | | | |
| EPP foam | 0.010 | kg | 120 | K | 0.42 Whkg*K | 1Wh | 0.001 kg |

| | | |
|---|---|---|
| Total | 4Wh | 0.007 kg |

although in practice there are many secondary effects which make a precise estimate unreliable.

The general aim is to minimise the amount of contact between the beads and condensation forming within the mould in order to produce moulded parts with lower moisture content.

In some embodiments, a post-moulding drying process is used.

Alternatively, venting may be arranged as part of the mould structure to allow excess steam to escape during the moulding process. Otherwise, steam may condense within the mould, for example on the metal electrodes.

FIG. 17 shows a simple two-layer mould 150, wherein a porous inner mould 155 is fitted inside an outer mould 160. The mould effectively comprises a double-walled vessel, the outer wall 160 is as per the standard mould; the inner wall 155 (defining the space where the beads are placed) is porous; a gap 170 between the walls allows for condensation to collect between the two mould layers.

Beads placed within the inner mould 155 are therefore kept separate from the condensation formed during the moulding process.

Optionally, a compressed air inlet 175 connected to the outer mould cavity allows the outer mould space 170 to be pre-pressurised and excess steam to be flushed out. Temperature and pressure are monitored by means of suitable probes.

This simple arrangement does not show any further venting to accommodate the filling step, which would be preferred in a commercial moulding system.

For larger-scale moulding, a simply-vented arrangement has venting solely via a system of core vents in the two RF plates. More advanced arrangements incorporate venting into the other four sides of the mould. A full two-layer mould can allow for the removal of condensation from all sides of the moulded part.

FIG. 18 shows examples of alternative vented RF moulding presses 180. Composite electrode structures 182 and 183, connected respectively to the top 184 and bottom 185 electrode plates via adapters 186, each comprise a vented cavity plate 187 (adjacent the moulding cavity) and a back plate 189 (nearer the electrode plate 184, 185), with a grid 188 located between. The porous inner mould or cavity plate 187 contains a series of holes or slits with dimensions smaller than the EPP beads. The gap between the two mould layers 187, 189 connects to an array of core vents 190 on the electrodes to enable venting (for example of steam and condensation which collects between the two mould layers and excess air after the filling) from within the EPP in moulding chamber 191 via pipe 192.

Pipe 192 can be used for introducing air and/or steam at the beginning of the moulding process and to remove air and/or steam at the end of cycle.

Venting of the moulding tool is needed during the filling phase, to allow injection of air into and/or removal of air from inside cavity, and also during the heating phase, to allow steam to exit the cavity. Venting also allows for the removal of any remaining water and the release of pressure at the end of the moulding cycle.

FIG. 18(i) shows a moulding press with a tool structure comprising an RF insulating material 195 located entirely between the RF press plates. The tool must therefore be able to withstand both the temperatures and mechanical stresses of the moulding process.

FIG. 18(ii) shows an alternative arrangement based on a metallic tool structure which uses RF transparent material 195 in the form of a coating or spacer pieces to prevent contact between the two electrodes. As the RF transparent material is not located directly between the RF press plates, it need only be able to withstand the temperature cycle, not the mechanical stresses of the moulding process.

### EXAMPLE V

### Towards a Production System

FIG. 19 shows a crack-fill moulding press 200 retro-fitted for use as an RF moulding system. This modified steam chest moulding press is designed to approximate on a small scale a commercial system and as such it makes use of several features which would be used in volume production.

FIG. 20 shows a production RF moulding sequence 300.

In summary, FIGS. 19 and 20 show, in simplified form, an exemplary system for manufacturing a moulded product by means of RF dielectric heating and illustrate, in overview, the typical stages in an exemplary moulding process.

The system comprises a mould chamber having an internal mould cavity that has an internal shape and dimensions which conform generally to the external shape and dimensions of the article to be moulded. Access to the mould cavity is provided by a closure which serves to seal the cavity during the moulding process and which can be opened to allow the moulded article to be ejected or otherwise removed after the moulding process is completed. As will be explained in more detail below, the closure is typically operated hydraulically.

An RF generator is used to generate an RF electromagnetic field between a pair of opposing or parallel plate electrodes arranged either side of a non-metallic spacer which forms part of the mould chamber.

The use of such an arrangement of electrodes, is particularly beneficial as it allows an existing system to be upgraded relatively easily without extensive modification to the mould tooling. For example, conventional steam chest moulding presses have pressure plates which could also be arranged to become RF electrodes thus opening up the possibility of allowing these systems to be modified to enable RF and to be retrofitted to improve efficiency.

The size of gap between the plates depends on the frequency and electric field strength to be generated. In particular, the size of the gap between the opposing plates depends on the thickness of the moulded article required. The other dimensions in the X & Y directions influence the choice of operating frequency where the electrode dimensions are ideally less than quarter (¼) wavelength.

The electric field strength that can be applied to the system is a function of the loss factor of the moulded particulate, the heat transfer fluid and the operating frequency. Where the electric field strength becomes too high arcing can occur between the electrodes.

In some embodiments, the electrode plates are maintained at a fixed separation by one or more spacers made of a suitable RF compatible material (although this may increase the applied voltage which may lead to arcing between the electrodes).

The mould chamber is manufactured of an RF compatible (transparent) material and is situated between the electrode plates, such that RF waves generated by the RF generator can travel through the chamber walls to irradiate the contents of the mould cavity.

The moulded article is moulded from a particulate start material which typically comprises expanded particles of a polymer resin such as expanded polypropylene ‘EPP’ or the like. The expanded particles comprise closed-cell beads that have been expanded as previously described from pre-cursor particles of the resin, typically in the form of pellets formed in an extrusion process.

Mould chamber further comprises a moulding material injection port via which the particulate start material is injected into the mould cavity for subsequent fusing (‘welding’) of the particles to form the moulded article. The process comprises essentially three steps:
(i) Beads of the start material are coated in a liquid heat transfer agent (in this case water) prior to introduction to the mould cavity, and are thus introduced to the mould cavity together via a mould material injection port.
(ii) The RF field produced by the RF generator is applied to dielectrically heat the liquid heat transfer medium, through the mould chamber walls, until the heat transfer medium boils to generate gas (in this case steam) at the required temperature. The steam heats the particles of start material, to their melting point temperature at their surfaces and to a lesser extent internally. Accordingly, the surfaces of the particles begin to soften and the pressure inside the particles increases (as the expansion agent is warmed). The softening of the surface, and the further (attempted) expansion of the particles in the mould cavity, cause the particles to weld to one another thereby forming the moulded article.
(iii) After the start material is fused and cooled to form the moulded article, the mould chamber is opened and the moulded article removed (potentially being ejected by means of mechanical ejector pins). It will be appreciated, however, that any suitable method may be used for ejecting the moulded article, for example using compressed air pressure, suction, or a combination thereof.

Such an RF system has several benefits over, say, a microwave system. Firstly, for example, RF radiation is more penetrative than microwave radiation (being of a lower frequency/longer wavelength). Furthermore, the generation of an RF field between the parallel plates is generally more controllable and predictable (and hence safer and more efficient) than irradiation by microwaves in a microwave chamber. More specifically, in a microwave system microwaves can potentially ‘ricochet’ around the microwave chamber unpredictably and hence non-uniformly. Indeed, one surprising potential benefit which has become apparent during experiments using RF (as opposed to microwaves) is the potential of RF to provide a greater uniformity in the moulded product and, in particular, the potential of RF to avoid ‘hot spots’ and ‘cool spots’ associated with microwave heating (which can possibly cause defects in the moulded article). As discussed above, these benefits arise, in part, because of the directional nature of the RF field compared to the more non-uniform, random heating associated with microwaves, and also because the wavelength (and penetrative capability) of RF radiation.

In a variation of the RF and microwave systems, EM radiation of sufficient power to flash boil the water into steam is used.

In another alternative, the heat transfer agent and the start material, could be introduced separately via separate dedicated injection ports (at the same time or at different times). Moreover, the heat transfer agent and the start material, could be introduced at different times via the same injection port. For example, the water could be introduced before or after the start material, in dependence on process requirements.

It will be appreciated that the water need not be heated directly in the mould cavity. In one variation, for example, the water is heated separately to generate steam before being introduced to the mould cavity, In this variation, the steam may by injected into the mould cavity under pressure or may be allowed to permeate through a porous partition between a vessel in which the water is heated and the mould cavity. Whilst these variations may appear more complex than direct heating in the mould cavity itself, they have the potential to remove the need to pre-coat the particles with water and/or to reduce the amount of drying required after the moulded article is formed.

In variations of these systems, the mould cavity and/or water vessel is pressurised to increase the temperature at which steam is formed. This allows moulding using beads of start material having a fusion temperature which significantly exceeds the boiling point of water at atmospheric pressure (˜100° C.). This is particularly beneficial for the moulding of polypropylene beads, which can have softening temperatures in excess of 120° C., even rising to 160° C. (in some cases higher). For example: pressurising the mould cavity/water vessel by an additional atmosphere to two atmospheres increases the boiling point to approximately 121° C. or so; pressurising the mould cavity/water vessel by two additional atmospheres to three atmospheres increases the boiling point to approximately 134° C.; pressurising the mould cavity/water vessel by three additional atmospheres to four atmospheres increases the boiling point to approximately 144° C.; and pressurising the mould cavity/water vessel by four additional atmospheres to five atmospheres increases the boiling point to approximately 153° C.

FIG. 21 shows a commercial steam chest moulding press 400 adapted for RF moulding. Features include:
Integration of an RF generator
   The HT connection could be to either the fixed or moving plate depending on press design. The HT plate must be isolated electrically from the second press plate and other press components and will need adequate clearance to avoid discharge. If the HT side is the moving plate insulated ceramic sleeves may be needed. For safety, the RF field may be contained within a Faraday cage and incorporate safety interlocks and other fail-safe features.
Reconfiguration of the steam manifold system.
   For the RF moulding process the size of this manifold should be minimised to reduce the quantity of water needed. This could comprise a porous grid positioned behind the vented plate which then connects to a pressure outlet port on a back plate.
Provision of bead injection ports and fill guns
   These may be linked to the pressure vessel, allowing for the introduction of pre-pressurized dry beads to the tool. In order to ensure the metal ends of the fill guns do not protrude into RF field they could be incorporated into say the ground electrode.
Pressure control
   Incorporation of compressed air lines and pressure relief valves allows control of vapour movement by application of positive and negative pressure.
Incorporation of water injection ports.

Such systems would be suitable for use as either in counterpressure-fill or crack-fill modes.

Specific features shown in FIG. 21 include:
RF ground plate 402 connected to generator. Minimum 100 mm distance to power. Individual per mould—has holes for fill guns and ejector positions
Massive or shaped mould 404
Male mould 406 and female mould 408 (both of polymer material)
Fill gun 410 (with non-conductive tip)
Ejector 411 (with non-conductive tip)
RF generator 412; RF ground 414; and RF power input 416
RF plate 418 connected to generator. Minimum 100 mm distance to ground.
Isolating support pillars 420, approx 150 mm (ceramic or other non-conductive material)
Support bars 422
Press/mould parting line 424
Press die plate fixed side 426
Possible aluminium side stabilisation frame 428
Side support 430

Process Considerations

For a commercial RF moulding system the basic process parameters of RF power, time and pressure will need to be optimised in light of the following considerations:
Water Usage
   Optimisation of the conditions for EPP moulding is expected to result in water usage of less than 5 kg water per cubic metre (<5 kg/m³) of moulded product.
Energy Consumption
   Energy consumption of the process will be closely linked to the quantity of water used. Monitoring of forward and reflected power as well as use of a power meter can be used to measure the process energy usage.
Cycle Time
   Ideally, the optimal cycle time will be comparable to that for steam chest moulding, if not shorter.
   This cycle time will be dependent on the power supply available—and may for example be shortened by switching from say a 5 KW to a 60 KW generator.
Moulding Uniformity
   Moulding within a simple rectangular shape is relatively straightforward with this process. Steam acts as a heat transfer agent, therefore uniform heating and fusion should be seen throughout the part. The exception may be at the mould surface where contact with a cold mould surface may result in poorer fusion. More pronounced effects may be seen in more complex parts where beads in thinner sections of mould experience extensive cooling from the mould walls. Uniformity within more complex parts could be examined by fitting polymer space-filling blocks into the rectangular shaped mould.

Regarding the latter, consideration may also be given to how the design of the moulding tool might be improved to enhance uniformity of the moulded product, for example, by improving the uniformity of the RF heating and/or making particular allowances for the moulding of more complex shapes. Suitable measures could include:
Mould surface treatment
   The need to provide a source of additional heat at the mould surface in order to achieve uniform heating throughout the part could be indicated by differences in surface temperature measurements at different places on the mould surface during a moulding process. Heating mechanisms could be incorporated directly into the electrode plates (either electric heating or via hot air) to pre-warm the electrodes. Alternatively, surface layers of materials such as carbon black or zeolite (or other RF-absorbing material) may be added to the inside of the dielectric component of the mould.
Field Shaping Elements
   Incorporation of water channels into the mould can be used to distort the RF field and provide additional heating in certain areas (for example thinner areas of complex shapes). Water channels could also be used to assist with cooling of the moulded part.
Electrode Shaping
   Optionally, shaped electrodes may be used to give good uniformity of heating. The results of modelling work would suggest the optimum shapes.
Mould shaping
   Furthermore, the mould itself could be shaped to allow for larger sample uniformity of bead fusing and/or to allow for easier removal of the moulded part. A larger mould would necessarily require a larger separation between the RF electrodes, which could mean the system would require consequent re-tuning.

### EXAMPLE VI

### Further Studies of RF Fusion of Polypropylene

A1. System Set-Up for Moulding Trials

RF Press Set-Up

All trials performed in the following studies were carried out using a small RF press operating at 13.56 MHz with the following key additions.
Inclusion of pressure sensors to monitor steam and foam pressure.
Use of fibre optic probes to measure temperature within the mould
Inclusion of a compression plate on the top electrode to mimic the crack-fill mechanism used in traditional EPP moulding.
Incorporation of a datalogging system

Inclusion of Sensors

Two main pressure sensors were used.
Foam sensor
Steam pressure sensor

Foam Sensor

The foam pressure sensor was fitted to the top plate of the press. In order to effectively measure the pressure of the foam this sensor needs to be in direct contact with the beads. However, the process also requires inclusion of porous inserts and compression plates on top of the moulded part. Furthermore, the sensor must be fitted within the top electrode and cannot penetrate into the RF field. This combination of factors made it difficult to maintain good contact between the beads and the sensor would only be effective in measuring foam pressure if the beads expanded significantly during processing. Otherwise it must be assumed that this sensor is measuring steam pressure above the beads.

For the small cylindrical mould the sensor was contained within the metal compression disc fitted to the top plate. This compression disc shielded the sensor from the RF field while also providing good contact with the beads (See FIG. 22).

For the tall square mould a deeper compression plate is needed and, due to the sensor fittings, it was not possible for the sensor to be fitted the full depth into this plate (see FIG. 23). This means that the foam sensor was generally not in good contact with the beads and was therefore measuring steam pressure rather than foam pressure.

FIG. 22 shows the sensor set-up for the cylindrical mould.

FIG. 23 shows the sensor set-up for the square mould. The set-up includes a foam sensor 1000, a top electrode 1002, a metal compression disc 1004, porous frit 1006, a PTFE mould 1010, beads 1008, and porous frit 1012.

Fibre Optic Temperature Probes

Fibre optic temperature probes were used in some trials. However these probes did not provide robust temperature measurements. Probes were placed in a thin glass-walled tube to prevent them being broken during the moulding process. This appeared to result in a noticeable time delay in measuring temperature rises and a poor correlation between temperature and pressure was observed. The glass tubes were also vulnerable to breaking in the process and damage to probes was observed in some instances. For the purpose of the trials within this project it was decided that it would be preferable to monitor process conditions by pressure only and the use of temperature probes was therefore abandoned for later trials.

This approach could be revisited if it is found to be important to record temperature within the samples.

Tooling Designs

Mould Geometries

Two moulds were constructed in this project. Both were constructed from thick walled PTFE to provide the required temperature and pressure resistance for the moulding process.
Small cylindrical mould
Tall square mould

The small cylindrical mould had a diameter of approximately 70 mm and a height of approximately 80 mm. The walls were slightly tapered to enable easy release of the product.

The tall square mould was 70×70 mm with a total internal height of 240 mm. The mould was made in 3 separate sections (each of depth 80 mm), with O-rings between sections to provide a pressure seal.

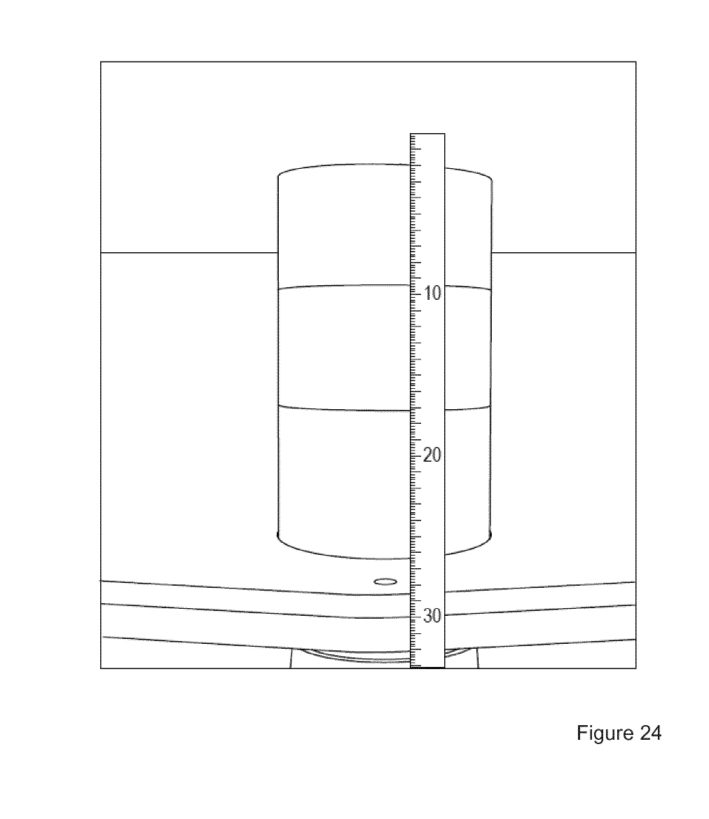

FIG. 24 shows an external view of the tall square mould.

Water Removal

Both moulds contained a porous frit at the base and a porous compression plate on the top. These plates provided a space within the mould for excess water to drain.

For both moulds the top porous plate contained a hole of diameter slightly larger than the foam sensor. This enabled beads to contact the foam sensor so that pressure readings of the expanding foam could be obtained. As noted earlier, in some instances effective contact between beads and the sensor was not achieved and pressure readings recorded represent steam pressure above the beads.

A2. Trials with Small Cylindrical Mould

Within the work using the small cylindrical mould two sets of trials were carried out
Establishing parameters for effective fusion of products
Investigation of varying process time and power

In all experiments the water used contained a small amount of salt to give a conductivity of 7.5 mS/m.

Establishing Parameters for Effective Fusion

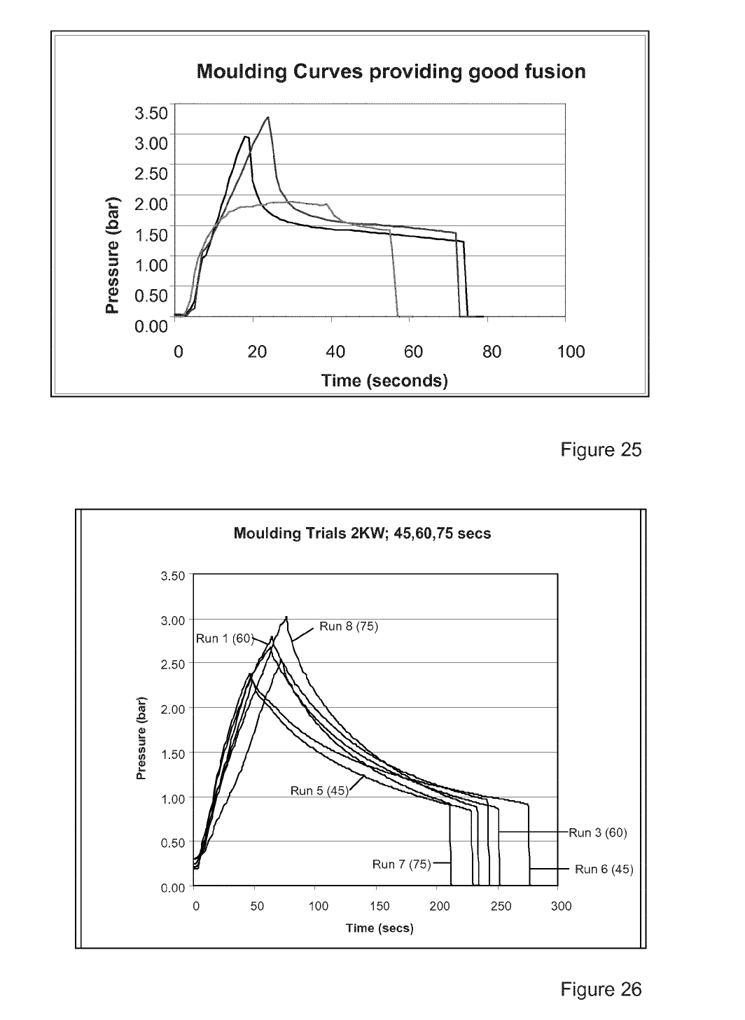

These trials were carried out using approximately 15 g of beads and 20 mL of water. Variations in heating time and power level were investigated and it was observed that well fused samples were obtained with a range of process conditions. Table 1 show the time and power levels for three runs all of which produced well-fused samples. FIG. 25 shows pressure curves for these runs.

In all instances following cessation of RF heating the product was allowed to cool in the mould for a period.

TABLE 1
Parameters for trials

| | | | | Pressure |
|---|---|---|---|---|
| | RF | | Heating | released |
| | Power | | Time (secs) | (secs) |
| Sample 2 | 2.5 | KW | 47 | 81 |
| Sample 5 | 4 | KW | 19 | 75 |
| Sample 8 | 4 | KW | 25 | 72 |

FIG. 25 shows pressure curves providing good fusion.

Variation in Process Parameters

Following these trials an additional set of process parameters was investigated. These trials were defined by a series of power and time parameters as shown in Table 2. All trials were repeated at least in duplicate and used 15 mL of water. Trials were carried out with both black and white beads and no significant difference between the two types was observed. Pressure was recorded using the form sensor which for these trials was in good contact with the expanding beads.

TABLE 2
Moulding trials at different power and time levels

| | | | Maximum |
|---|---|---|---|
| | Power | Heating | pressure |
| | Level | Time | reached |
| Run Nos. | (KW) | (secs) | (bar) |
| 5-6 | 2 | 45 | 2.3-2.4 |
| 1-4 | 2 | 60 | 2.6-3.0 |
| 7-8 | 2 | 75 | 2.6-3.0 |
| C-D | 2.7 | 35 | 1.8-2.0 |
| A-B | 2.7 | 45 | 3.0-3.2 |
| E | 2.7 | 60 | 2.9 |
| 16-17 | 3.3 | 25 | 1.8-2.3 |
| 10,11,13 | 3.3 | 35 | 2.4-2.7 |
| 14-15 | 3.3 | 45 | 2.4-3.0 |

In all instances following cessation of RF heating the product was allowed to cool in the mould until a pressure of approximately 1 bar was reached. Due to the high insulation provided by the thick-walled PTFE mould this rate of cooling was observed to be slow.

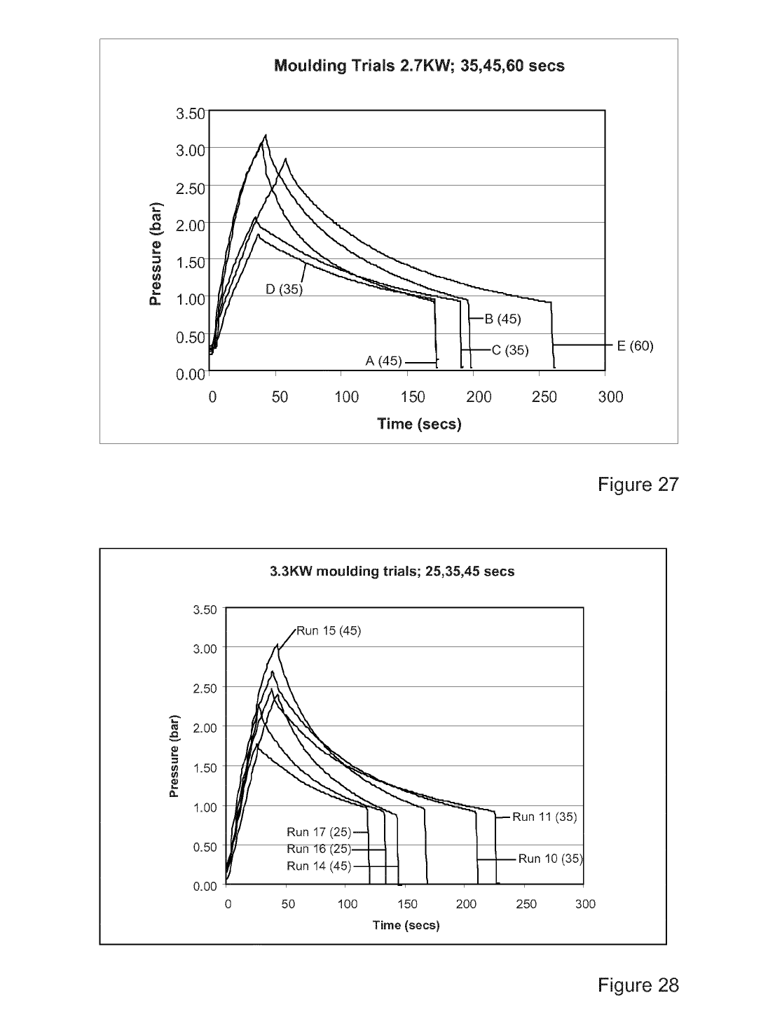

FIGS. 26, 27, and 28 show pressure profiles for trials carried out at the three different power levels—2 KW (FIG. 26); 2.7 KW (FIG. 27); and 3.3 KW (FIG. 28).

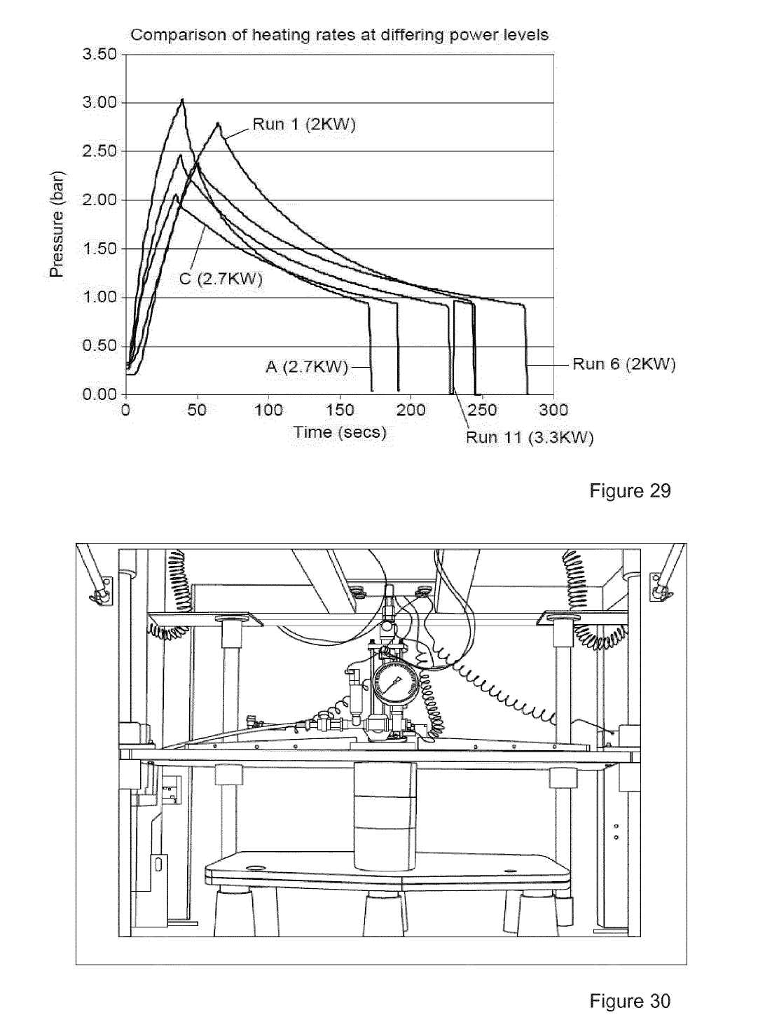

FIG. 29 shows a comparison of the heating rates achieved by variation in power levels.

The graphs in FIGS. 26 to 29 illustrate that considerable variation in heating rate can be observed while using nominally the same RF power. Given that the quantity of beads and water used in each of these trials is the same it would be expected that only a minimal variation in heating rate would be seen. The following factors may, however, influence the actual heating rate observed.
Heat transfer to the mould; the mould will gradually warm up with repeat trials. A slower heating rate may be seen in the first run of a series as higher heat losses to the mould could occur.
Pressure leaks in the system; some small pressure losses will occur in the system, for example between the O-ring seal of the tool and the press top plate. These may vary between trials
Variation in levels of reflected power and RF system losses; 15 mL of water is a small load and consequently heating efficiency is likely to be lower than normal for an RF system. System losses will vary between trials
   Levels of reflected power were seen to vary both during and between trials; however this reflected power was not recorded and therefore cannot be correlated with heating rate.

Despite these sources of variation it is generally observed that at higher power levels, more rapid heating of the sample if observed.

Visual examination of moulded products indicated that a good level of fusion was achieved. All samples produced by these trials were sent for evaluation of mechanical properties. This evaluation has shown that the sample posses a very good level of internal fusion.

A3. Trials with Tall Square Mould

Equipment Set-Up

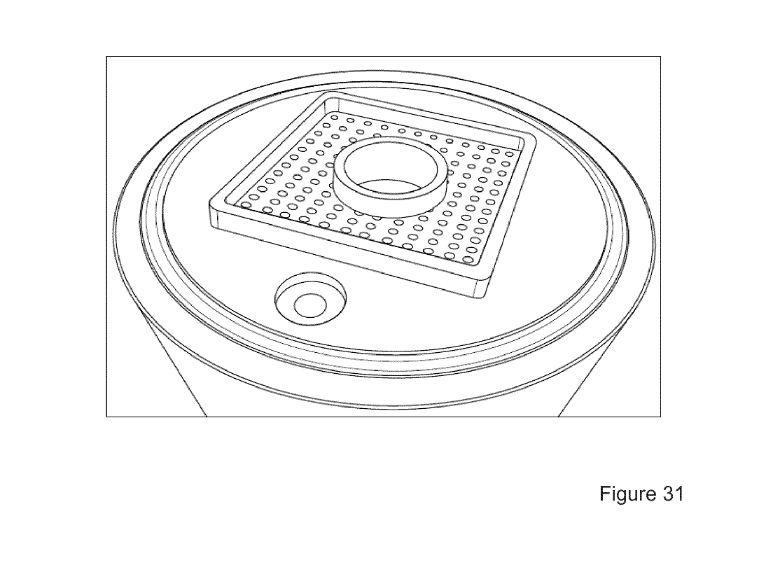

A series of trials were carried out using the tall square mould described above in section A1. The set-up for moulding trials with the large mould of these trials is shown in FIG. 30.

Within these trials pressure was recorded using both the foam sensor and a simple pressure transducer fitted above the top electrode. The system was also fitted with a pressure gauge which was used to visually observe pressure rises during the process and was used to determine the end point of the moulding process.

The tool contained a porous frit above a cavity in the base of the mould which enabled excess water from the process to collect. A porous frit containing a central hole (to enable contact of beads with the foam sensor) was also used on the top of the mould. This second porous frit also provides a space for excess steam/water and provides some compression of the beads.

FIG. 31 shows a top view of this porous frit, where an internal view of the mould containing the porous frit compression plate can be seen.

Finally, a 20 mm deep metal compression plate was fitted to the top plate of the press. Between this metal plate and the top porous frit a total compression of 40 mm was achieved to provide moulded parts with a height of 200 mm.

Moulding Results & Identification of Operational Parameters

In all experiments the water used contained a small amount of salt to give a conductivity of 7.5 mS/m. A similar mass of ≈50 g dry beads was used in all experiments; this is the mass of dry beads which fills the mould cavity in the absence of any compression.

Pressure was recorded on both the foam sensor and the simple pressure transducer.

All pressure curves reported below are based on readings from the foam sensor. However the lack of good contact between the expanding beads and the sensor membrane (as illustrated in FIG. 23) means that this sensor is effectively measuring steam pressure above the mould rather than the pressure of the foam.

In all trials, the product was allowed to cool in the tool to a pressure of about 1 bar.

Procedure

The procedure involved the following simple process which is comparable to the method utilised for moulding of the small cylindrical samples.
Fill mould with beads
Place mould in press
Add water to top of mould
Close press and apply RF

For the larger mould this approach was successful in producing moulded articles, however the increase in pressure observed was generally slow and good fusion was not always achieved. In some instances only small sections of the beads fused under these conditions.

This was attributed to poor distribution of water throughout the beads. This was a result of having a water reservoir at the base of the mould; to effect full fusion the steam will have to pass around or through the fused beads in the base of the mould. To improve the distribution of water throughout the mould, later trials were conducted using pre-soaked beads.

Use of Pre-Soaked Beads

Beads were placed in a porous container and weighted down to hold them under water in a tank. Beads were left to pre-soak for 1-4 hrs before being used in moulding trials. These ‘wet’ beads contained no free water but simply had water bound to the surface by surface tension.

The use of pre-soaked beads showed a significant improvement in fusion results. However, in most cases only part fusion of products was seen. Most significantly the top section of the product was generally very poorly fused and often consisted entirely of loose beads.

Within these trials a couple of completed fused samples were obtained. However there appeared to be no obvious correlation between reaction conditions and effective fusion. Table 3 illustrates the variability of trial results obtained using similar process parameters.

TABLE 3
Trials using pre-soaked beads

| | | | mass | | | Max | |
|---|---|---|---|---|---|---|---|
| | | | of | Water | Bead | Pressure | |
| | Beads | Power | beads | volume | preparation | (bar) | Fusion |
| Sample | White | 2.2 KW | 52 g | 50 mL | none | 1.7 | poor: |
| 1 | | | | | | | some |
| | | | | | | | chunks |
| | | | | | | | fused |
| | | | | | | | material |
| Sample | White | 2.2 KW | 52 g | 50 mL | premixed | 2.3 | Complete |
| 3 | | | | | with water | | shape |
| | | | | | | | but some |
| | | | | | | | loose |
| | | | | | | | beads at |
| | | | | | | | periphery |
| Sample | White | 2.2 KW | 52 g | 50 mL | presoaked | 2.3 | Bottom |
| 4 | | | | | in water | | 2/3 of |
| | | | | | | | shape |
| | | | | | | | fused; |
| | | | | | | | loose |
| | | | | | | | beads at |
| | | | | | | | top |
| Sample | Black | 2.2 KW | 52 g | 50 mL | premixed | 2.2 | Bottom |
| 5 | | | | | with water | | 2/3 of |
| | | | | | | | shape |
| | | | | | | | fused; |
| | | | | | | | loose |
| | | | | | | | beads at |
| | | | | | | | top |

“Black” beads comprise around 3 wt %, typically between 0.5-5 wt %, carbon black.

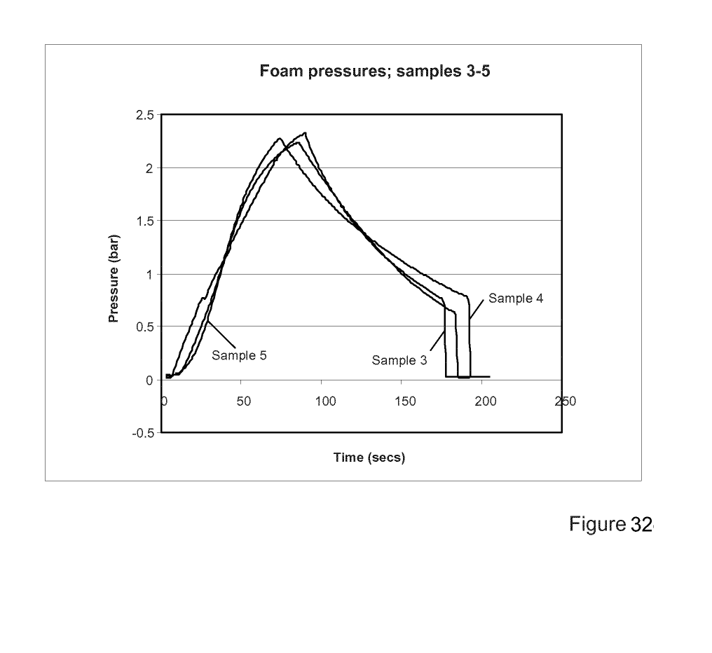

FIG. 32 shows pressure profiles for trials listed in Table 3 with pre-soaked beads, illustrating the variability of results obtained using similar process parameters.

Use of an Air Reservoir

The final modification made to the trial equipment was the inclusion of an air reservoir (approximate volume 200 mL). This was included to provide a space for air to be pushed into during the trial and ensure that the entire of the mould is filled with steam to promote fusion. All trials used within this work used pre-soaked beads.

These trials consistently gave fully-fused products.

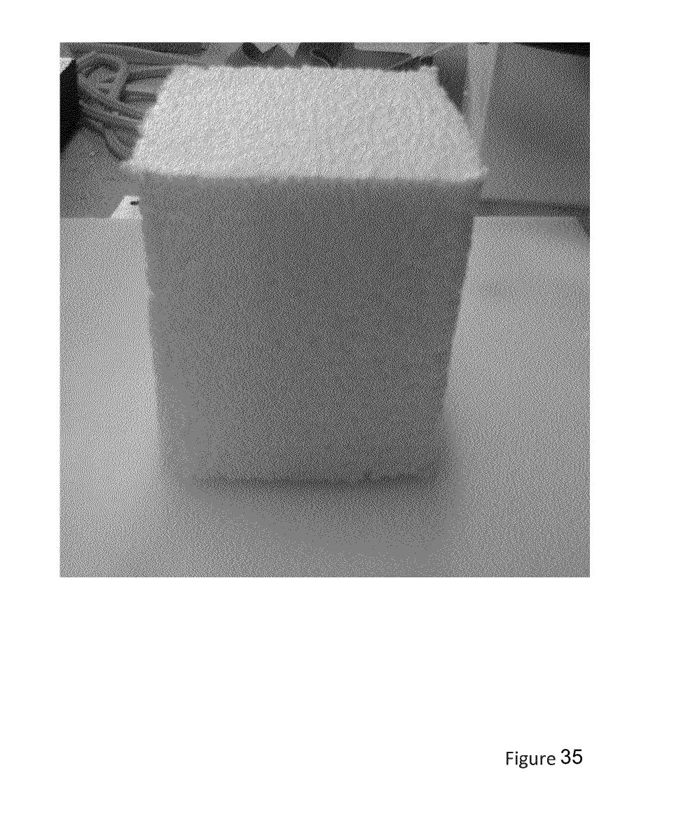

FIGS. 34 and 35—and Table 4—show the process conditions used and the pressure profiles obtained.

For all tests products were allowed to stand in the tool until the pressure had dropped to approximately 1 bar. As apparent from FIGS. 34 and 35, the time to reach this pressure shows considerable variation between runs. As our tool is comprised of three sections held together by the press there will be a small amount of pressure leakage between sections; the rate of this may vary between runs.

There are two runs included in these trials which show very different pressure profiles to the others.

The first is labeled ‘unmixed beads’. In this case the beads were mixed with water directly before the run. By contrast, all other beads samples had been soaked in water for a minimum of an hour. This pre-soaking seems to give a better distribution of water throughout the beads and facilitates heating. The ‘unmixed beads’ sample showed a very slow rate of heating and in some instances gave relatively poor fusion.

The second sample which is noteworthy is Sample 11. In this instance the O-ring was left off the top of the mould. This resulted in water being able to escape from the tool and the pressure within the fusion process remaining relatively low. However, this sample still appears well fused and was obtained in a drier form than other samples.

TABLE 4
Trials with air reservoir

| | | | | Heating | Max | |
|---|---|---|---|---|---|---|
| | | Water | Power | time | pressure | |
| | Beads | volume | level | (sacs) | (bar) | Comments |
| Sample 1 | Black | 30 mL | 3.2 KW | 72 | 2.8 | Slower heating rate possibly |
| | | | | | | due to use of cold tool (first |
| | | | | | | run of the day) |
| Sample 2 | Black | 30 mL | 3.2 KW | 53 | 2.8 | |
| Sample 3 | Black | 30 mL | 3.2 KW | 56 | 3.3 | |
| Sample 4 | Black | 30 mL | 3.2 KW | 61 | 2.9 | |
| Sample 5 | Black | 12 mL | 3.2 KW | 83 | 2.7 | Reduction in water volume |
| | | | | | | gives slower heating rate |
| Sample 6 | Black | 12 mL | 3.2 KW | ≈80 | ≈2.5 | Pressure curve not recorded |
| Sample 7 | Black | 20 mL | 3.2 KW | 67 | 2.5 | |
| Sample 8 | Black | 20 mL | 3.2 KW | 85 | 2.9 | |
| Sample 9 | White | 30 mL | 3.2 KW | 60 | 2.7 | |
| Sample 10 | White | 30 mL | 3.2 KW | 65 | 2.8 | |
| Sample 11 | Mixed | 30 mL | 3.2 KW | 72 | 1.9 | Low pressure due to poor |
| | | | | | | seal on top of tool; allowed |
| | | | | | | water to escape so produced |
| | | | | | | drier sample |

“Black” beads comprise around 3 wt %, typically between 0.5-5 wt %, carbon black.

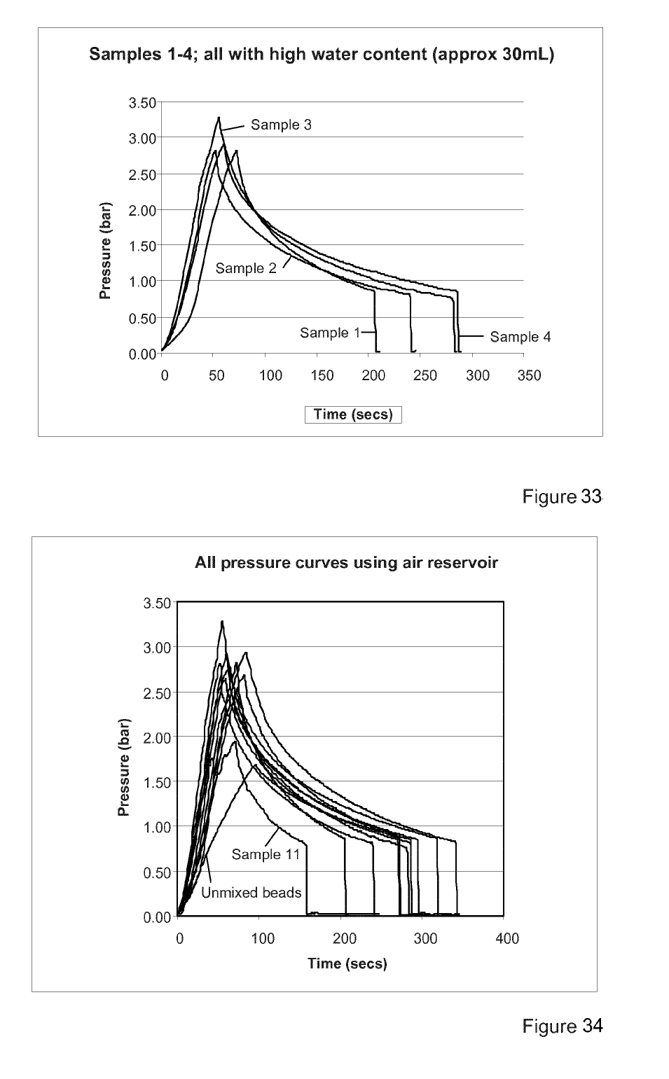

FIG. 33 shows pressure profiles for trials 1-4 listed in Table 4 (comparable moulding conditions).

FIG. 34 shows all moulding trials 1-11 listed in Table 4.

Summary of Moulding Trials with Taller Shape

Trials carried out with this taller mould showed that obtaining effective fusion of this shape was considerably more difficult than for the smaller cylinder previously investigated. The following process improvements were considered to be important in order to obtain complete fusion throughout the mould.
Use of pre-soaked beads to provide an even distribution of water throughout the mould.
Pressurisation of the tool prior to RF heating to increase water boiling point and then temperature of the produced steam
Management of the steam flow by use of an exhaust valve or by use of an air reservoir, to remove air and ensure heat exchange between steam and expanded particles.

The following factors may influence the quality of fusion obtained.
Extent of compression; Within the tall square mould approx 17% compression was used (compressing 240 mm height to 200 mm), Compression used for the small cylinder was approx 30%.
Proportion of water: The relative amount of water used is smaller in the square mould than the cylindrical mould. Although it is assumed that in both instances the water volume is considerably in excess of that required to achieve fusion this has not been confirmed.
Distribution of water: The need for pre-soaking of beads for the tall mould shows the importance of an even water distribution within this larger shape. Prolonged soaking of beads or use of a surfactant may be beneficial in obtaining a better level of fusion.

### EXAMPLE VII

### Further Parameterised Studies of RF Fusion of Polypropylene

Further to the trials described above, further studies were undertaken using different equipment. This included a larger, “15 kN” (150 kN) moulding press with the following parameters:
Horizontal/60 kN hydraulic clamping force
Tool internal dimensions: 130×130×30 mm
Plates dimensions: 980×680 mm
RF Generator with max. 15 kW power at electrode

Generally, the procedure used is as follows:
1) Particles are mixed with water at various content defined in the tables below. Mixing is done for a sufficient time to achieve uniform coating of particles by water.
2) Particles are placed manually inside the tool to completely fill the cavity. A 4 mm perforated plastic plate is added onto the top to produce mechanical compression during closing of the plates.
3) Press is closed
4) Air pressure is applied prior to HF heating. Air pressure was set at various levels.
5) HF heating is switched on at certain power level and for a certain time.
6) Pressure is quickly released at the end of HF heating via an exhaust valve, depressurising the mould to atmospheric pressure. 1-5 seconds is needed to release all the pressure inside.
7) Press is kept closed 100 s in order to allow cooling of the part.

Various materials were tested, including:
White expanded polypropylene particles, ARPRO® 3133
Black expanded polypropylene particles, ARPRO® 5135, with around 3 wt % of carbon black
Grey expanded polypropylene particles ARPRO® 4133, with from 0.5 to 1 wt % of carbon black
White expanded polyethylene particles, ARPAK® 4313

Water content values are given in millilitres (ml) or equivalently milligrams (mg) per unit litre volume of moulding cavity, which is considered to be a more useful measure than the % mass values which are also sometimes used.

Results:

The quality of the resultant moulding was evaluated and rated on a scale from “1” to “5” according to table below for each set of parameters.

Moulding evaluation

| 1 | 2 | 3 | 4 | 5 |
|---|---|---|---|---|
| No reaction | Agglomerate | Partially | Can mould, but | Good |
| | | fused | partially not fused | |

Influence of Water Content & Initial Pressurization Pressure

Fixed Parameters:
Tool: 130×130×30 mm
HF power: 50% of maximal value for 50 seconds

| White ARPRO ® 3133 | | Initial pressure prior to starting HF heating | | | | | |
|---|---|---|---|---|---|---|---|
| 33 g/l density beads | | | 1.0 | 1.5 | 2.0 | 2.5 | 3.0 |
| Water | 8 ml/l | Moulding | | | 3+ | | |
| content | (25%) | evaluation | | | | | |
| (in ml/ | | Max pressure | | | 2.6 | | |
| litre of | | reached | | | | | |
| mould | 11 ml/l | Moulding | | | 4− | | |
| cavity) | (33%) | evaluation | | | | | |
| | | Max pressure | | | 2.5 | | |
| | | reached | | | | | |
| | 16.5 ml/l | Moulding | 5 | 5 | 5 | 5 | 5− |
| | (50%) | evaluation | | | | | |
| | | Max pressure | 1.5 | 2.0 | 2.5 | 3.0 | 3.6 |
| | | reached | | | | | |
| | 33 ml/l | Moulding | 5 | 5 | 5 | 5 | 5 |
| | (100%) | evaluation | | | | | |
| | | Max pressure | 1.5 | 2.0 | 2.6 | 3.0 | 3.6 |
| | | reached | | | | | |

| Black ARPRO ® 5135 | | Initial pressure prior to starting HF heating | | | | | |
|---|---|---|---|---|---|---|---|
| 35 g/l density beads | | | 1.0 | 1.5 | 2.0 | 2.5 | 3.0 |
| Water | 9 ml/l | Moulding | | 4 | 3+ | | |
| content (in | (25%) | evaluation | | | | | |
| ml/litre of | | Max pressure | | 2.1 | 2.6 | | |
| mould | | reached | | | | | |
| cavity) | 12 ml/l | Moulding | | 5 | 4 | | |
| | (33%) | evaluation | | | | | |
| | | Max pressure | | 2.0 | 2.6 | | |
| | | reached | | | | | |
| | 17.5 ml/l | Moulding | 5 | 5 | 4 | 4 | 4 |
| | (50%) | evaluation | | | | | |
| | | Max pressure | 1.6 | 2.1 | 2.6 | 3.1 | 3.6 |
| | | reached | | | | | |
| | 35 ml/l | Moulding | | 5 | 5 | | |
| | (100%) | evaluation | | | | | |
| | | Max pressure | | 2.0 | 2.6 | | |
| | | reached | | | | | |

| | | Initial pressure prior to |
|---|---|---|
| Grey ARPRO ® 4133 | | starting HF heating |
| 33 g/l density beads | | 3.0 |
| Water content | 33 ml/l | 5 |
| (in ml/litre of | (100%) | n/a |
| mould cavity) | | |

| | | Initial pressure prior to | |
|---|---|---|---|
| White ARPRO ® 4313 | | starting HF heating | |
| 16 g/l beads | | 0.5 | 1.0 |
| Water content | 16 ml/l | 5 | 5 |
| (in ml/litre of | (100%) | n/a | n/a |
| mould cavity) | | | |

Evidently, the initial pressurisation was to a pressure less than the highest pressure subsequently maintained during moulding, typically to 0.6 bar less, generally to less than 1 bar less, preferably to less than 0.5 bar less, or even to less than 0.25 bar less, or to less than 0.1 bar less than the highest pressure maintained during moulding. Additional pressure results from the increase in temperature of the (air and water) environment inside the tool as steam is generated.

Influence of Water Content & RF Heating Time

Fixed Parameters:
Tool: 130×130×30 mm
HF power: 50% of maximal value
Water content fixed at 50%, 16.5 mg per litre of moulding cavity
Initial pressure fixed at 2.0 bars.

| Water content 50% | | Heating time (sec) | | | | | |
|---|---|---|---|---|---|---|---|
| Initial-pressure 2, 0 bars | | 25 | 30 | 35 | 40 | 45 | 50 |
| White ARPRO ® 3133 | Moulding | 4− | 4− | 3 | 4+ | 5 | 5 |
| | evaluation | | | | | | |
| | Max pressure | 2.5 | 2.5 | 2.5 | 2.5 | 2.6 | 2.6 |
| | reached | | | | | | |

Subsequently, well-fused larger samples of size 120×120×150 mm were made under the following conditions:
Power: 4000 W for 90 s (60 s provided acceptable fusion)
Initial pressure of 2 bars
Water content: 16.5 mg per litre of moulding cavity

FIG. 35 shows an example of an example of a well-fused larger sample.

In summary, features of the invention may include one or more of the following:
The application of RF energy to expanded particles or beads of thermoplastic material contained in a mould or tool in the presence of a heat transfer fluid such as water, or predominantly water.
Apparatus comprising a pair of parallel plate electrodes—forming a dielectric capacitor—connected to an RF generator and a mould located between the plates, the apparatus adapted to apply an RF field to material placed in the mould.
The RF generator comprising a solid state or self-excited oscillator together with a matching system which adjusts the frequency and impedance of the circuit.
The gap or spacing between the electrodes may be adjustable in dependence on the material being processed; preferably, in order to vary the frequency and hence the RF power and electric field strength applied.
The apparatus may comprise a hydraulic, pneumatic or mechanical press, comprising two opposing press platens and RF electrodes which form the side walls of the moulding chamber.
The heating of the expanded particles or beads via the heating of the heat transfer fluid by the applied RF to an elevated temperature sufficient to cause softening of the outer surfaces of the particles, preferably wherein the temperature of the heat transfer fluid is used to heat the particulate to its fusion temperature.
The heat transfer fluid is heated to the vapour or gaseous state sufficient for it to permeate into the cellular structure of the particles to maintain or expand their physical dimensions.
The fusing or welding together of the particles in the mould to produce a moulded article (as defined by the shape of the mould), preferably the resulting article comprising a homogenous mass of fused particles.
The frequency of the RF energy being such that the associated wavelength, preferably a quarter-wavelength, is comparable to or greater than the average size or a linear dimension of the article to be moulded.
The heat transfer fluid being adapted, preferably by the addition of one or more of:
   a conductivity-increasing impurity, for example a salt such as sodium chloride or potassium chloride, to enhance its coupling with the applied electro-magnetic field (the exact conductivity required being a function of the applied voltage, which in turn is related to the applied power and the operating frequency);
   a fusion-enhancing additive, such as poly-vinyl acetate or a soluble fat (eg. palm oil), to enhance fusing of the particles; and
   a surfactant, to enhance surface tension between the fluid and the particles.
Generally, the conductivity of the water used a heat transfer agent may be of 3-5 mS/m, or preferably 6-7 mS/m or more preferably approximately 7.5 mS/m. Trials have achieved moulding at conductivities of up to 70 mS/m, although issues may arise with the use of such high conductivity values. The conductivity values cited are typically +/−1 mS/m, +/−0.5 mS/m or even +/−0.1 mS/m.
The heating of the heat transfer fluid encompassing at least one, preferably two changes of phase or state.
The use of RF resulting in heating of the heat transfer fluid in a first mode (ionic heating) when the heat transfer fluid is in a liquid state and in a second mode when the heat transfer fluid is in a gaseous state, wherein heating in the first mode is dominant such that the heating by the applied RF predominantly occurs when the heat transfer fluid is in the liquid state, therefore the heating of the heat transfer fluid (and consequently the particles) becoming self-limiting as the heat transfer fluid vaporises.
The mass of heat transfer fluid used in the moulding of an article may be comparable to, preferably less than, that of the total mass of particles being formed into the moulded article (as in a 1:1 ratio, preferably less than 2:1 ratio).
The amount of heat transfer fluid placed in the mould is between 1 ml and 100 ml per litre of tool cavity.
The raising of the pressure within the mould (typically to 0.5 bar, to at least 1 bar, preferably to at least 1.1 bar, potentially up to 3 bar or even 5 bar or higher) in order to raise the temperature at which the heat transfer fluid vaporises, preferably such that at least some of the heating of the particles occurs as the heat transfer fluid is in a liquid state and preferably in contact with the particles, more preferably such that the heat transfer fluid begins to vaporise at the approximate temperature at which softening of the outer surfaces of the particles occurs.
The plate electrodes are adapted to maintain pressure against a seal to counter pressure arising from the vaporised heat transfer fluid during the heating and moulding stages.
The removal of air from the mould by vaporised heat transfer fluid before moulding, for example venting via a valve or into an air reservoir (either dedicated or for example piping), in some instances allowing a portion of the heat transfer fluid to be discharged from the mould cavity.
The control of the temperature in the mould at least in part by means of control of the pressure within the mould, potentially only partially vaporising the heat transfer agent.
The maintaining of the elevated pressure and temperature for a time sufficient to result in the formation of the moulded article.
Use of a porous surface lining of the mould to manage exchange between the inside and the outside of the tool.
The release of the pressure in the mould soon after fusing (moulding) of the particles has occurred (as may be indicated by the desired pressure and therefore temperature corresponding to the particle fusion temperature having been achieved), thereby allowing the beads to expand, filling the mould.
The cooling of the RF electrodes and moulding tool with water, for example:
   cooling water may be applied to both platens when the RF system is either a vertical or horizontal press orientation
   cooling water may alternatively or also be applied onto the moulded part in, or once removed from, the mould
   the moulding tool may be fitted with a water jacket for cooling, for example such that the water jacket has channels around its periphery where deionised or distilled water can be circulated, preferably the water in the jacket being ejected after cooling with air
   air or water blowers or compressed air may be used to cool once the moulded part has been removed.
The control of the particle or bead density by pre-treatment of the beads by the application of pressure to the beads before moulding, either by mechanical means (for example, by use of a compression plate) or physical means, for example by the application of pressurised gas, such that a gas (typically air) is introduced into the beads which will expand when heated, expanding the beads.
The manufacture of a mould, preferably comprising one or more of ceramic, polymer or glass, for example by casting and firing a ceramic such as Alumina or Mullite or by machining special ceramics such as MICOR or Pyrophyllite. The latter is a machinable ceramic which can be fired to improve its mechanical properties, and once fired has an operating temperature of over 500° C. Pyrophyllite heats up slightly at most RF frequencies so that it could give some heating to the sides of the mould.
The second mould material may comprise polyvinylidene fluoride (PVDF) or a material that has a loss factor similar or close to that of the polypropylene bead and a fluid mixture at the fusion temperature.

Further alternative embodiments based on those described above will be evident to the skilled person.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A method of manufacturing a moulded article from expanded resin particles, the method comprising:
placing the particles and a dielectric heat transfer fluid in a mould located between a pair of electrodes;
generating a radio-frequency electromagnetic field between the electrodes;
applying the electromagnetic field to the mould to dielectrically heat the heat transfer fluid and hence the particles; and
heating the particles to a temperature sufficient to cause their surfaces to soften, so that the particles fuse, thereby to form the moulded article as shaped by the mould.

2. A method according to claim 1, wherein the radio-frequency electromagnetic field has a wavelength greater than an average dimension (or dimensions) of the moulded article.

3. A method according to claim 1 or 2, wherein the radio-frequency electromagnetic field has at least one of:
i) a wavelength of between 300 m and 1 m;
ii) a frequency between 1 MHz-300 MHz, 1 MHz-100 MHz, 1 MHz-40 MHz, or 3 MHz-30 MHz;
iii) a frequency within an Industrial, Scientific and Medical band allocated for industrial heating; and
iv) a quarter-wavelength greater than an average dimension of the moulded article.

4. A method according to claim 3, wherein the radio-frequency electromagnetic field has a frequency within +/−10 MHz of one of: 13.56 MHz, 27.12 MHz and 40.68 MHz.

5. A method according to any preceding claim, wherein the temperature to which the heat transfer fluid is heated is sufficient to cause it to vaporise, optionally to fully vaporise.

6. A method according to claim 5, the method further comprising maintaining a pressure in the mould such that the vaporisation temperature of the heat transfer fluid is at or near the softening temperature of the surfaces of the particles.

7. A method according to claim 5 or 6, wherein the applied radio-frequency electromagnetic field results in heating of the heat transfer fluid in a first mode when the heat transfer fluid is in a liquid state and optionally in a second mode when the heat transfer fluid is in a gaseous state.

8. A method according to claim 7, wherein the heating by the applied radio-frequency electromagnetic field of the heat transfer fluid in the first mode is dominant over the heating in the second mode such that the heating of the heat transfer fluid predominantly occurs when the heat transfer fluid is in the liquid state, preferably in contact with the particles.

9. A method according to any preceding claim, wherein the amount of heat transfer fluid placed in the mould is determined in dependence on the volume of the mould cavity, and is preferably between 1 ml and 100 ml, more preferably between 2 ml and 50 ml, yet more preferably between 4 ml and 25 ml, per litre of cavity.

10. A method according to any preceding claim, wherein the mass of heat transfer fluid placed in the mould is determined by the mass of particles placed in the mould, preferably, wherein the mass of heat transfer fluid placed in the mould is in the range 0.1 to 50, 0.125 or 0.14 to 20 or 25, 0.25 to 2, more preferably 0.5 to 1.25, times the mass of particles.

11. A method according to any preceding claim, wherein the heat transfer fluid comprises water.

12. A method according to claim 11, wherein the water has added to it a conductivity increasing impurity.

13. A method according to claim 12, wherein the conductivity increasing impurity is a salt.

14. A method according to any preceding claim, wherein the heat transfer fluid has a conductivity of over 3 mS/m.

15. A method according to any preceding claim, wherein the heat transfer fluid is either:
i) placed into the mould at the same time as the particles; and/or
ii) pre-mixed with the particles before being placed in or injected into the mould.

16. A method according to any preceding claim, wherein the heat transfer fluid is used in combination with a wetting agent.

17. A method according to any preceding claim, wherein the method further comprises controlling the temperature in the mould at least in part by means of control of the pressure within the mould.

18. A method according to any preceding claim, wherein the method further comprises maintaining the mould at an elevated pressure during moulding, preferably, wherein said elevated pressure is up to 3 bar, preferably up to 5 bar, preferably between 2 and 3 or 3 and 5 bar.

19. A method according to any preceding claim, wherein the method further comprises pressurising the mould before moulding,

20. A method according to any preceding claim, wherein the elevated temperature to which the particles are heated is between 80° C. and 180° C., preferably between 105° C. and 165° C., preferably up to 110° C., 120° C., 130° C., 140° C. or up to 150° C.

21. A method according to any of claims 17 to 20, wherein the elevated pressure and temperature within the mould is maintained for a sufficient time to result in the formation of the moulded article from the fusion of the particles.

22. A method according to any preceding claim, further comprising pressurising the particles in the mould before moulding.

23. A method according to claim 22, wherein pressurising the particles comprises compressing the particles mechanically or physically, for example by counterpressure filling, by preferably 5-100 vol %.

24. A method according to any preceding claim, further comprising removing air from the mould, preferably, displacing the air by the vaporised heat transfer fluid, preferably venting the air via a valve or into an air reservoir, optionally before completion of the moulding.

25. A method according to any preceding claim, further comprising depressurising the mould after fusing of the particles has occurred, preferably as soon as fusing of the particles has occurred.

26. A method according to any preceding claim, further comprising venting the vaporised heat transfer fluid from the mould.

27. A method according to any preceding claim, further comprising a cooling step after moulding, preferably, wherein the cooling step comprises at least one of
i) injecting pressurised gas into the mould; or
ii) cooling at least one surface of the mould or an electrode, preferably, wherein the cooling step comprises channelling fluid along at least one surface of the mould or an electrode.

28. A method according to any preceding claim, wherein the particles comprise, consist of or are closed-cell foam particles.

29. A method according to any preceding claim, wherein the resin comprises, consists of or is an aliphatic resin.

30. A method according to any preceding claim, wherein the resin comprises, consists of or is a polyolefin.

31. A method according to claim 30, wherein the resin comprises, consists of or is a non-aromatic polyolefin (ie polyalkene).

32. A method according to claim 31, wherein the resin comprises, consists of or is polypropylene and polyethylene.

33. A method according to claim 31, wherein the resin comprises, consists of or is polypropylene.

34. A method according to claim 31, wherein the resin comprises, consists of or is polyethylene.

35. A method according to any of claims 1 to 32, wherein the resin comprises, consists of or is a copolymer, preferably polypropylene and its copolymer or polyethylene and its copolymer.

36. A method according to any preceding claim, wherein the method further comprises controlling the particle or bead density by pre-treatment of the particles, preferably by pre-pressurising the particles before moulding in order to introduce a gas into the particles.

37. A method according to claim 36, wherein the particles are pre-pressurised externally of the mould and subsequently transferred to the mould, preferably, wherein the particles are stored in a pressure tank at an elevated pressure.

38. A method according to any preceding claim, wherein the mould comprises an enclosed or partially enclosed cavity.

39. A method according to any preceding claim, wherein the mould material comprises a material substantially transparent to the radio-frequency electromagnetic field generated between the plate electrodes, preferably, wherein the mould material comprises
i) a polymer, such as polypropylene, high-density polyethylene, polyetherimide or polytetrafluoroethylene; or
ii) a ceramic such as alumina, mullite, MICOR or Pyrophyllite.

40. A method according to any preceding claim, wherein the mould further comprises a second material not substantially transparent to the radio-frequency electromagnetic field generated between the plate electrodes, preferably wherein the second mould material forms a side wall or lining of the mould and is adapted to be in direct contact with the article being moulded.

41. A method according to any preceding claim, wherein the electrode plates are spaced apart with a dielectric or electrically non-conducting spacer material, preferably, wherein the spacer material defines at least one side wall of the mould, more preferably, wherein at least one side wall of the mould is embedded in a plate electrode.

42. A method according to any preceding claim, wherein art least one side of the mould cavity is in direct contact with at least one electrode.

43. A method according to any of claims 5 to 44, wherein the mould is adapted to withstand the elevated pressure due to the vaporisation of the heat transfer fluid.

44. Apparatus for manufacturing a moulded article from particles, comprising:
a pair of electrodes;
means for generating a radio-frequency electromagnetic field between the electrodes;
a mould, located between the electrodes; and
means for applying the electromagnetic field to the mould;
wherein the apparatus is adapted to dielectrically heat a heat transfer fluid and particles placed in the mould to a temperature sufficient to cause the particle surfaces to soften, so that the particles fuse, thereby to form the moulded article as shaped by the mould, preferably, further comprising at least one of
i) means for placing the particles and the heat transfer fluid in the mould, for example by crack or counterpressure filling;
ii) plate electrodes;
iii) means for compressing the particles; or
iv) means for pressurising the mould.

45. Apparatus according to claim 44, wherein the spacing between the electrodes is adjustable in dependence on the material being processed; preferably, in order to vary the properties of the electromagnetic field applied.

46. A moulded product obtained using the method of any of claims 1 to 43 or using the apparatus of claim 45 or 46.
